(19) United States
(12) Patent Application Publication
(10) Pub. No.: US 2013/0232064 A1
(43) Pub. Date: Sep. 5, 2013

(54) CASH HANDLING DEVICES

(71) Applicant: Samuel H. Bosch, Portland, OR (US)

(72) Inventor: Samuel H. Bosch, Portland, OR (US)

(21) Appl. No.: 13/844,259

(22) Filed: Mar. 15, 2013

Related U.S. Application Data
(63) Continuation-in-part of application No. 13/085,394, filed on Apr. 12, 2011.
(60) Provisional application No. 61/616,945, filed on Mar. 28, 2012.
(60) Provisional application No. 61/766,647, filed on Feb. 19, 2013.

(51) Int. Cl. G06Q 10/10; G07F 19/00

(52) U.S. Cl. CPC G06Q 20/1085; G07F 19/202
USPC 705/43; 235/379

(57) ABSTRACT

A currency receiving device (CRD) includes a currency recycler configured to accept, count, deposit, and withdraw merchant currency inserted into the CRD, a network interface, and a processor in communication with the currency recycler and the network interface. The processor is configured to transmit to a financial institution or a home office, via the network interface, an indication of an amount of merchant currency inserted into the CRD over a predetermined period of time. In some embodiments, the processor determines whether a second predetermined period of time passes during which no merchant currency is inserted into the CRD. In some embodiments, the processor determines an amount of deposited merchant currency does not meet a predetermined minimum deposit corresponding to the predetermined period of time. Alert messages, based on insufficient or untimely deposits, duress, or tampering, are optionally produced.

### RELATED APPLICATIONS

This application claims priority benefit of U.S. Provisional Patent Application Nos. 61/324,079, 61/616,945, and 61/766,647; and is a Continuation-in-Part of U.S. patent application Ser. No. 13/085,394. Each aforementioned patent application is hereby incorporated by reference in its entirety.

### BACKGROUND INFORMATION

The field of the present disclosure relates generally to currency dispensing devices (CDDs), such as automated teller machines (ATMs); to currency receiving devices (CRDs), such as provisional-cash safes (PCSs); and to systems and methods for servicing CDDs and CRDs.

Before the advent of remote cash capture systems, a merchant needed to have cash physically transported to a financial institution so that the cash could be deposited into the merchant's account, at which point the financial institution would credit the merchant's account for the deposited cash. FIG. 1 illustrates a prior art remote cash capture system 100 that allows funds to be electronically deposited into a merchant's account at a financial institution 110 before the cash is physically transported to the financial institution 110.

During the normal course of business, a merchant 120 receives cash 115 from its customers. The merchant 120 can then insert 125 all or a portion of the cash 115 into a PCS 130, which is typically located at the merchant's location (e.g., in a back office or under a counter). The PCS 130 provides security for cash acquired from customers by allowing the merchant 120 to remove cash from its point-of-sale (POS) terminal (e.g., cash register) and place the cash 115 securely in the PCS 130 where the cash 115 is secured with limited access. The PCS 130 periodically transmits 135 to the financial institution 110 an indication of the amount of money that has been inserted into the PCS 130 and the financial institution 110 credits the merchant's account accordingly. An armored truck periodically makes a site visit to transport 140 the cash 115 from the PCS 130 to the financial institution 110. The financial institution 110 then counts the cash 115 delivered by the armored truck and reconciles the credit the financial institution 110 previously gave the merchant 120 for the amount of money transmitted 135 with the amount of money transported 140 and delivered by the armored truck.

The remote cash capture system 100 allows the merchant 120 to obtain credit for the cash 115 that is in the PCS 130 before the cash 115 is physically transported from the PCS 130 to the financial institution 110. For example, the merchant 120 can issue payroll checks from the merchant's account at the financial institution 110 using the credit the merchant 120 received from the financial institution 110 for the amount of money that is inserted into the PCS 130.

FIG. 2 is a simplified block diagram illustrating a system 200 in which a financial institution 210 services an ATM 220. Initially, an armored truck transports 230 cash from the financial institution 210 to the ATM 220 and the cash is inserted into the ATM 220. Each time an ATM user withdraws cash 240 from the ATM 220, the ATM 220 causes an electronic fund transfer (EFT) 250 to take place from the ATM-user's bank account 260 to the financial institution 210. Thus, the merchant's account at the financial institution 210 is reimbursed for the cash that is dispensed by the ATM 220.

Traditionally, an ATM and PCS are serviced at different times and by different armored truck services even though the ATM and PCS are located at the same merchant-site. For example, one armored truck service transports cash from a financial institution to an ATM and inserts that cash into the ATM on one day and another armored truck service removes the cash from the PCS and transports that cash to a financial institution at some later date.

### SUMMARY OF THE DISCLOSURE

Described are improved systems and methods for operating, controlling, and servicing cash handling devices, such as PCSs and ATMs. Also described are improved CRDs. Additional aspects and advantages will be apparent from the following detailed description of embodiments, which proceeds with reference to the accompanying drawings.

### BRIEF DESCRIPTION OF THE DRAWINGS

FIG. 1 is a simplified block diagram illustrating a prior art remote cash capture system.

FIG. 2 is a simplified block diagram illustrating a financial institution servicing an ATM according to known methods.

FIG. 3A is a block diagram illustrating a system for servicing a CDD and CRD disposed at a merchant location, according to one embodiment.

FIG. 3B is a block diagram illustrating a system for servicing CDDs and CRDs disposed at multiple merchant locations, according to one embodiment.

FIG. 4 is a flow diagram illustrating a method of servicing a CDD and a CRD, according to one embodiment.

FIG. 5 is a block diagram illustrating a system for servicing CDDs and CRDs in which vault cash within the CDD belongs to a merchant, according to one embodiment.

FIG. 6 is a block diagram illustrating a system for servicing CDDs and CRDs in which vault cash within the CDD belongs to a financial institution, according to one embodiment.

FIG. 7 is a block diagram illustrating a system for servicing CDDs and CRDs in which vault cash within the CDD belongs to a service provider, according to one embodiment.

FIG. 8 is a block diagram illustrating a system for servicing CDDs and CRDs disposed at a first merchant location and a CDD disposed at a second merchant location.

FIG. 9 is a block diagram illustrating a system for servicing CRDs and CDDs disposed at a first merchant location and a CRD disposed at a second merchant location.

FIG. 10 is a block diagram illustrating a system for servicing cash handling devices, such as CRDs and CDDs, that also includes a debit POS terminal and a remote deposit capture (RDC) device.

FIG. 11 is a block diagram illustrating operational components of a CRD, according to one embodiment.

FIG. 12 is a block diagram illustrating a first operating mode of the CRD of FIG. 11, according to a first embodiment.

FIG. 13 is a block diagram illustrating a second operating mode of the CRD of FIG. 11, according to a second embodiment.

FIG. 14 is a block diagram illustrating a third operating mode of the CRD of FIG. 11, according to a third embodiment.

FIG. 15 is a screen capture of a dashboard overview report for a CRD.

FIG. 16 is a screen capture of a dashboard communication status report for a CRD.

FIG. 17 is a screen capture of a dashboard safe report for a CRD showing banknote levels for deposit or recycling cassettes of a CRD.

FIG. 18 is a screen capture of a dashboard total cash position report for all CRDs in a merchant's portfolio.

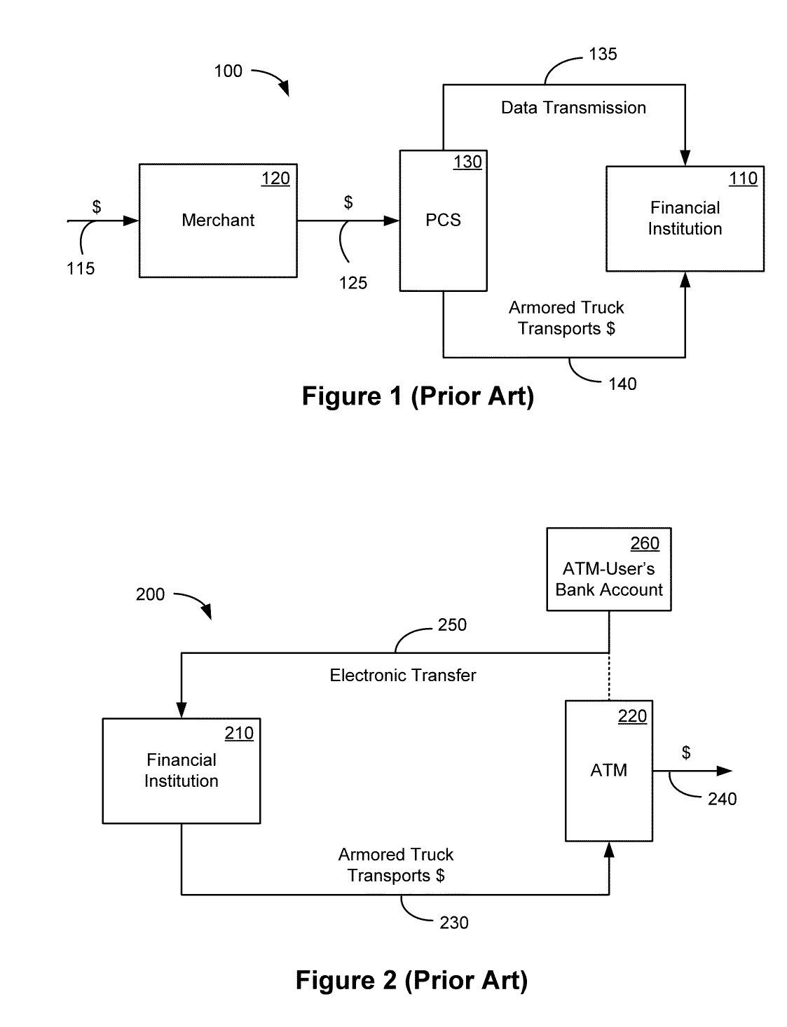

### DETAILED DESCRIPTION OF THE EMBODIMENTS

For the sake of clarity and conciseness, certain aspects of components or steps of certain embodiments are presented without undue detail where such detail would be apparent to skilled persons in light of the teachings herein, or where such detail would obfuscate an understanding of more pertinent aspects of the embodiments. The embodiments described are illustrative examples and should not, therefore, be considered as limiting this disclosure.

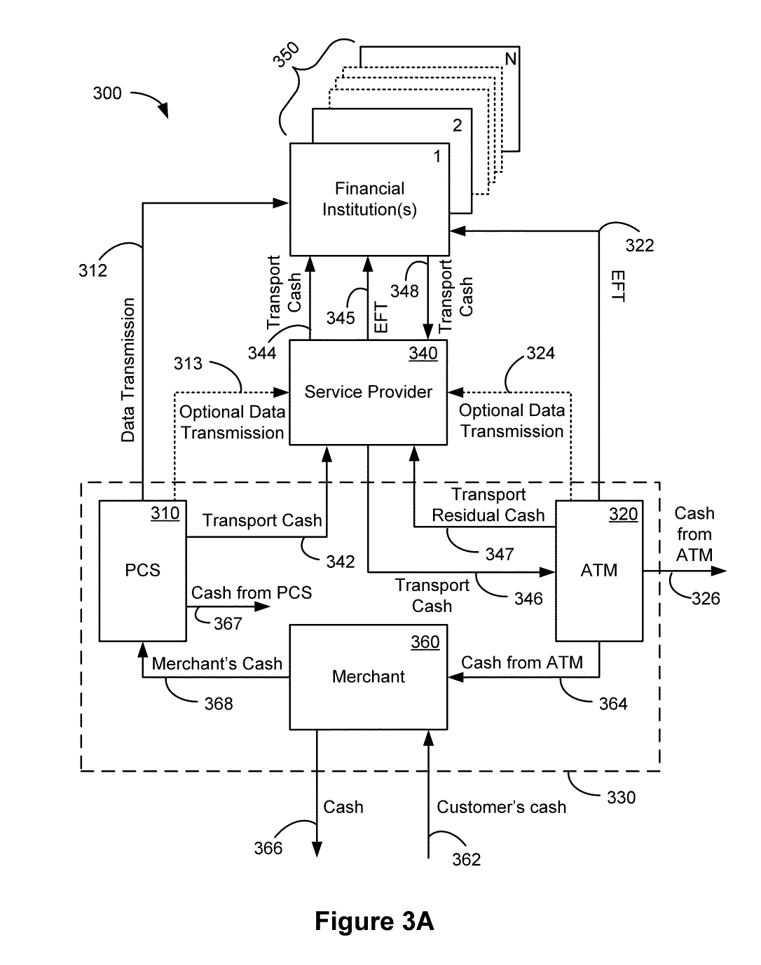

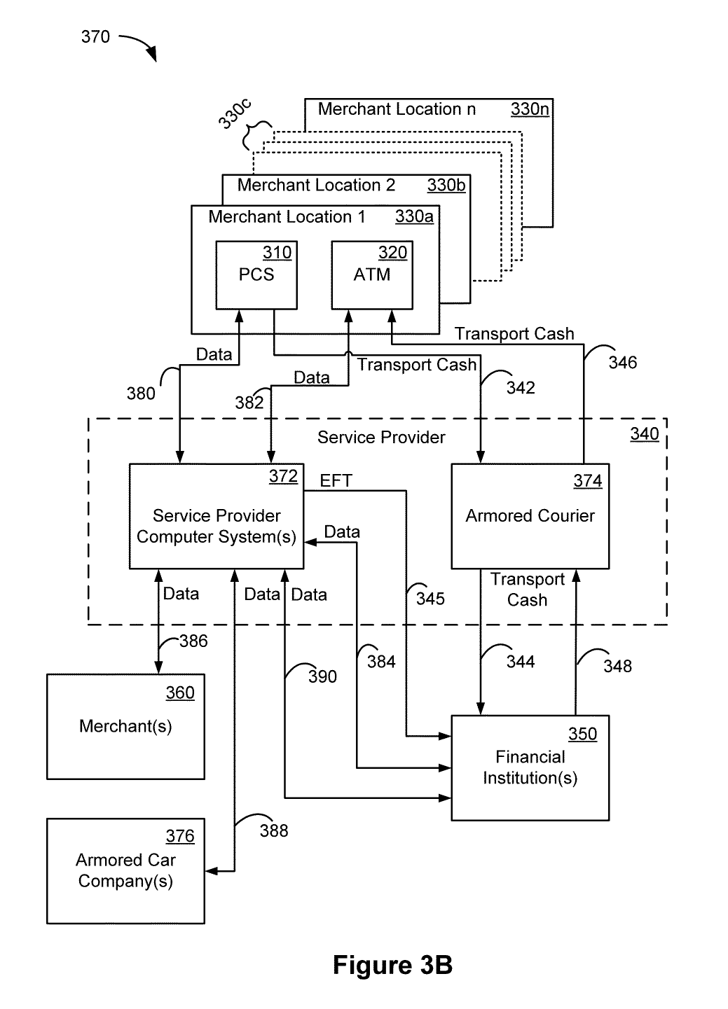

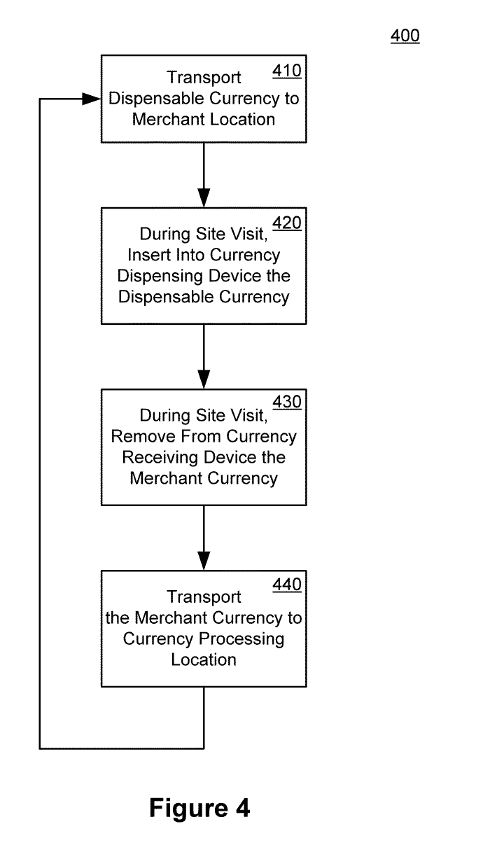

FIG. 3A is a block diagram illustrating a system 300 for servicing a CRD 310, such as a PCS, and a CDD 320, such as an ATM, which are both disposed at a merchant location 330. According to one embodiment, a method of servicing a CDD (e.g., ATM 320) and a CRD (e.g., PCS 310) disposed at a merchant location 330 comprises transporting 346 to the merchant location 330 dispensable cash for insertion into the CDD 320 during a site visit to the merchant location 330. During the site visit, the dispensable cash is inserted into the CDD 320. In addition, during the same site visit, the service provider 340 removes from the CRD 310 merchant cash that was inserted into the CRD 310 over a period of time by the merchant 360. After removing the merchant cash, the service provider 340 transports 342 the cash to a currency processing location to process the merchant cash removed from the CRD 310. After transporting 342 the merchant cash to the currency processing location, the service provider 340 may allocate a portion of the cash from the CRD 310 to be physically transported 344 to a financial institution 350 associated with the merchant 360. As will be described in more detail with reference to FIG. 4, the remainder of the cash from the CRD 310 is set aside to replenish the CDD 320 at the merchant location 330 (or a CDD of another merchant) during a subsequent site visit. The service provider 340 also causes an EFT 345 in the amount of the remainder to be made from a bank account of the service provider 340 to the financial institution 350. For ease of discussion, the system 300 will be described with reference to one service provider 340 servicing a single merchant location 330. However, as will be apparent from reading the following disclosure, the system 300 is equally applicable to one or more service providers servicing one or more merchant locations. In addition, the cash flow in the system 300 may involve one or more financial institutions 350.

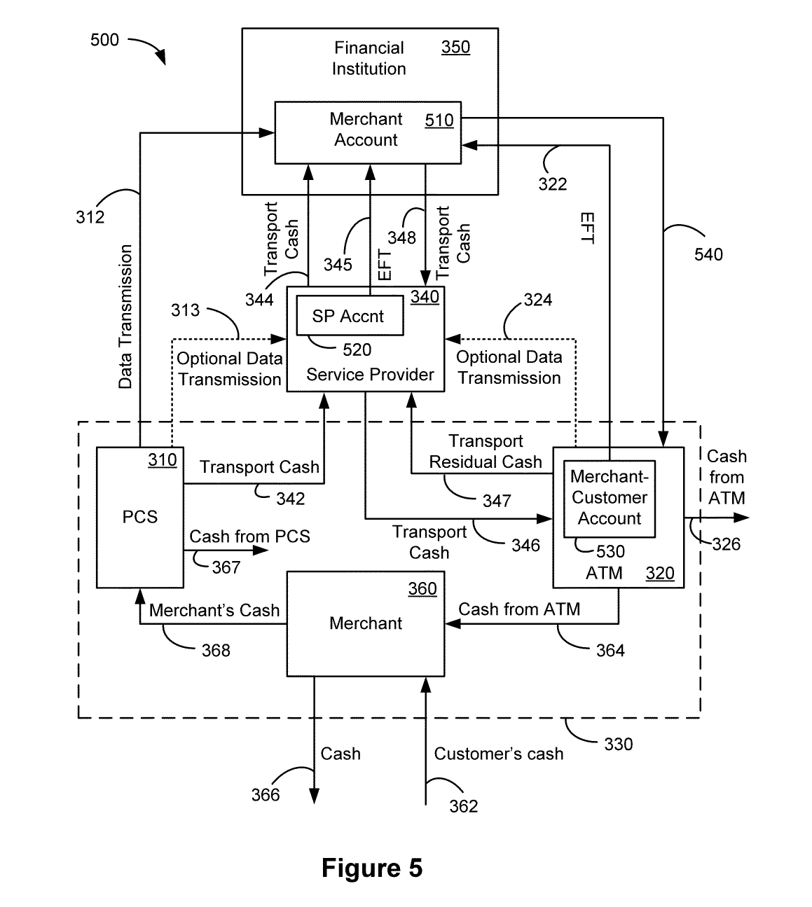

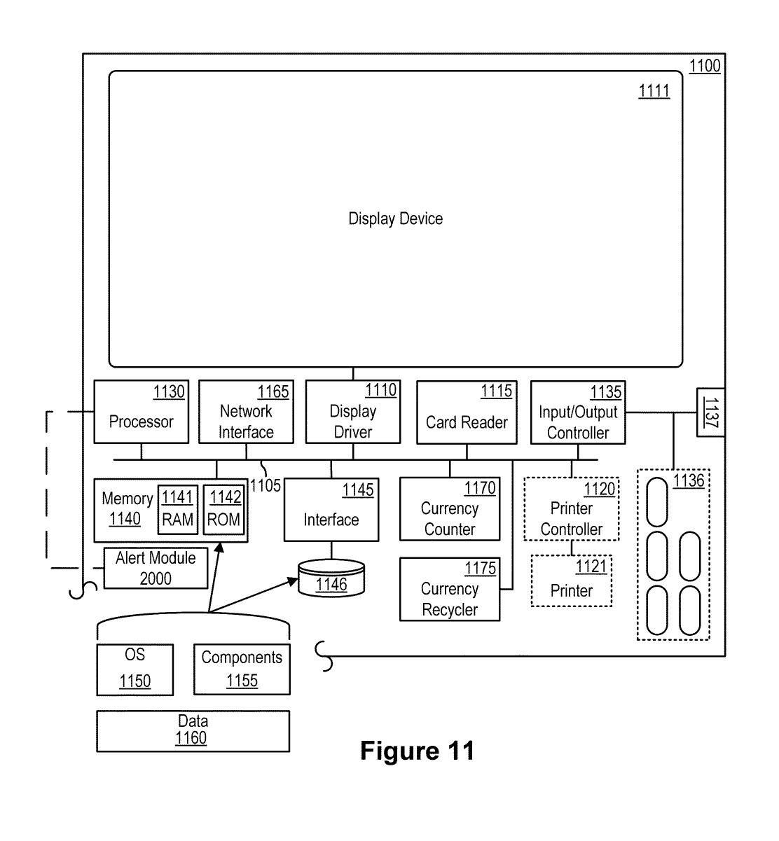

During the ordinary course of business, a merchant 360 receives cash from its customers in exchange for the goods, services, or both, that the merchant 360 provides. As used herein, cash refers to money in the physical form of legal tender currency, such as banknotes and coins. The cash received by the merchant 360 may be cash 362 that the customer has brought to the merchant location 330 or may be cash 364 that the customer has withdrawn from the on-site CDD 320. The merchant 360 may also give to the customer (or another individual) cash 366. For example, the merchant location 330 may have gaming stations, such as video poker machines, and the merchant 360 may pay winnings to the customer in the form of cash 366. By way of another example, the merchant 360 may give to the customer cash 366 in the form of change. By way of still another example, the merchant 360 may use cash 366 to pay for goods or services received, such as a cash on delivery (COD) transaction. The merchant 360 typically handles cash transactions at a POS, which may include a POS terminal, such as a cash register, general-purpose computer, or special-purpose computer, that includes hardware, software, or both, for processing transactions. The merchant 360, a merchant-employee, or a merchant-customer, may withdraw additional cash from the CDD 320 if, for example, the merchant 360 does not have sufficient cash available at the POS to pay out video poker winnings, which is described in greater detail with reference to FIGS. 5, 6, and 7. The merchant 360 (e.g., a merchant-employee, such as a manager or clerk) may withdraw cash 367 from the CRD 310 to, for example, pay winnings to a merchant-customer (e.g., if the merchant location 330 has gaming stations, such as video poker machines), fill the cash register, or pay for goods or services received (e.g., COD), which is described in greater detail with reference to FIG. 11.

After receiving cash, the merchant 360 may insert or feed 368 the cash into the CRD 310 or other remote cash capture or CRD. The CRD 310 is, according to one embodiment, configured to count cash inserted into the device and transmit to a financial institution an indication of a total amount of cash inserted into the device over a period of time so that the merchant is provided a credit by the financial institution for all or a portion of the cash inserted into the device over the period of time. In other words, credit is provided to the merchant's bank account before the cash is physically transported from the device to the financial institution. The merchant 360 or a merchant-employee may feed the cash into the CRD 310 immediately after receiving the cash or at some later time. For example, the merchant may periodically insert the cash (e.g., at the end of the day, at the end of the merchant-employee's shift, or every couple of hours) or after a certain amount of cash has been collected.

According to one embodiment, the CRD 310 includes a safe, a cash counter, a wired or wireless network interface, and other associated electronics. The CRD 310 counts the inserted cash (and possibly validates the cash using an optical scanner) and stores the inserted cash within the safe. For example, the CRD 310 stacks the inserted cash into cassettes within the safe.

According to one embodiment, the CRD 310 comprises a PCS. Suitable PCSs include the 2400 series (including the 2460 and 2470 series) cash counting and validation safes offered by Armor Safe Technologies, LLC, The Colony, Tex. (http://www.armorsafe.com/), for example. Another suitable PCS includes the Arca8000D cash recycler offered by ArcaTech Systems of Mebane, N.C. (http://www.arcatechsystems.com/). Another suitable PCS is available from Tidel Engineering of Carrolton, Tex. (http://www.tidel.com). The CRD 310 may also comprise a CDD that dispenses, in response to a request made by a user, currency independently of an EFT network. For example, U.S. Pat. No. 7,726,557, which is hereby incorporated by reference in its entirety, describes a currency dispense and control systems and methods. According to some embodiments, the CRD 310 does not comprise a computerized vending machine and is not configured to dispense a product, such as a beverage, a lottery ticket, or a prepaid calling card. In addition, the CRD 310 is not configured to provide to the service provider 340 or the financial institution 350 an indication of the product sold in exchange for the cash that is inserted into the CRD 310.

The network interface is provided to communicate (e.g., via a wired or wireless network) with an appropriate financial institution 350 and allows the CRD 310 to transmit 312 to the financial institution 350 an indication (e.g., a data file or bit stream) of the amount of cash that is stored within the safe so that the financial institution 350 can credit the merchant's account for that cash (or a portion thereof). For example, after the merchant 360 inserts or feeds 368 the cash into the CRD 310, the financial institution 350 receives a data transmission 312 (e.g., daily or after each deposit or periodically) indicating the amount of money that has been inserted into the CRD 310 so that the financial institution 350 can credit the merchant's bank account accordingly (e.g., within 24 hours or the next business day). Thus, the CRD 310 tracks deposits, verifies the amount of the deposits, and allows the financial institution 350 to credit the merchant 360 for the deposits before the cash is physically transported to the financial institution 350 thereby eliminating the delays, risks, and expenses associated with physically transporting the cash from the merchant location 330 to the financial institution 350.

In addition to, or as an alternative to, transmitting 312 to the financial institution 350 an indication of the amount of cash that is stored within the safe, the CRD 310 may transmit 313 to the service provider 340 (or another location, such as a server of a courier service or armored car company or a merchant server that communicates with CRDs disposed at various merchant locations) an indication of the amount of cash that is stored within the safe. For example, the CRD 310 may transmit 313 to the service provider 340 an indication of the amount of cash that is stored within the safe and the service provider 340 may relay that data to the financial institution 350. By way of another example, the CRD 310 may transmit to both the financial institution 350 and the service provider 340 an indication of the amount of cash that is stored within the safe, which may help the service provider 340 determine when to service the CRD 310 (e.g., remove cash from the CRD 310). According to one embodiment, the data transmission 312, the data transmission 313, or both, is accomplished independently of an EFT network, such as an interbank network (examples include PLUS, Cirrus, Interac, Star, Pulse, Maestro, or Accel/Exchange). In other words, the CRD 310 may communicate with the computer system of the financial institution 350, the computer system of the service provider 340, or both, without using any EFT networks. The CRD 310 may instead communicate with the computer system of the financial institution 350, the computer system of the service provider 340, or both, using a suitable public network, such as the internet.

The cash within the CRD 310 is periodically removed from the CRD 310. According to one embodiment, the merchant cash removed from the CRD 310 is transported directly from the merchant location 330 to the financial institution 350 (e.g., without stopping at a currency processing location). According to another embodiment, the merchant cash removed from the CRD 310 is transported 342 to a currency processing location or service-provider location, such as a room of the service provider 340 for counting cash or processing EFTs. The currency processing location may include equipment for processing the cash, such as a cash counting machine, a facing machine that orients bills to face in a common direction, and one or more service provider computer systems.

Cash within the CRD 310 is removed from the CRD 310 and dispensable cash (i.e., cash that was transported 346 to the merchant location 330) is inserted into the CDD 320 during the same site visit. The PCS cash may be transported 342 by the service provider 340 itself or by a courier service that is operated or contracted by the service provider 340, such as regional courier service or a national courier service (e.g., Brink's U.S. of Coppell, Tex.; or Loomis of Houston, Tex.). The service provider 340 or the courier service may utilize an armored vehicle (e.g., car, truck, or van) to transport the cash. After the cash has been transported 342 to the service-provider location, the service provider 340 allocates all or a portion of the cash from the CRD 310 to be physically transported 344 to a financial institution 350 associated with the merchant 360 (e.g., the transported cash may be deposited into the bank account of the merchant 360 or used to offset the credit the financial institution 350 previously extended to the merchant 360 for the cash the merchant 360 fed into the CRD 310). The remainder of the cash from the CRD 310 (i.e., the cash from the CRD 310 that is not physically transported 344 to the financial institution 350) may be set aside to replenish the CDD 320 at the merchant location 330 (or a CDD of another merchant) during a subsequent site visit. To make whole the financial institution 350, the merchant 360, or both, an electronic or automated transfer of funds 345, such as an EFT or automated clearing house (ACH) transfer, is made from a bank account of the service provider 340 to the financial institution 350 associated with the merchant 360 in the amount of the remainder to offset the credit the financial institution 350 previously extended to the merchant 360. In other words, because the financial institution 350 previously credited the merchant's account for the cash the merchant 360 fed into the CRD 310, the financial institution 350 should receive from the service provider 340 the tangible cash from the CRD 310 or an electronic deposit for the difference. The service provider 340 may optionally count the cash (e.g., using a cash counting machine) to verify the cash-count data reported by the CRD 310 or the service provider 340 may rely on the cash-count reported by the CRD 310.

One or more of the financial institutions 350 (e.g., financial institution 1 through financial institution N) may comprise a bank, credit union, credit card company, stock brokerage, or other institution that collects funds from the public to place in financial assets such as stocks, bonds, money market instruments, bank deposits, checking account deposits, or loans. The financial institutions include a computer system (e.g., server, storage device, and/or database) suitably programmed to receive the data transmissions from the CRD 310 and possibly send data to the CRD 310. The service provider 340 may also include a computer system (e.g., server, storage device, and/or database), such as service provider computer system 372 in FIG. 3B, suitably programmed to send and receive data from one or more of the CRD 310, the CDD 320, the financial institution 350, and the merchant 360 (e.g., via a computer system of the merchant 360, which may include a server, storage device, and/or database). The computer system of the service provider 340 communicates (e.g., via a network interface) with one or more of the CRD 310, the CDD 320, the financial institution 350, and the merchant 360 using a suitable communications network. In addition, the CRD 310 communicates with the computer system of the financial institution 350 using a suitable communications network.

The data communications may be encrypted or unencrypted. The communications network may comprise any suitable means of connecting one device to another for the purpose of transmitting and receiving data. Thus, the communications network may comprise a network that facilitates either one or both of wired and wireless communication between electrical devices over either one or both of short distances, such as a local area network (LAN), and unlimited or nearly unlimited distances, such as the internet. For example, the communications network may comprise a public switched telephone network (PSTN), a short-range network (e.g., Ethernet and IEEE 802.11), a long-range network (e.g., WiMAX), and wide-area cellular telephone networks (e.g., 2G, 3G, and beyond 3G cellular telecommunication networks). Thus, the communications network may comprise a wide area network (WAN), such as the internet, along with the associated modems, internet service providers (ISPs), servers, gateways, switches, and other associated components. Additionally, the communications network may comprise a cellular network of base stations along with the associated network and switching subsystems, PSTN, internet protocol (IP) packet transmitting networks (e.g., GPRS core networks), servers, gateways, switches, and other associated components.

In addition, any one of the CRD 310, the CDD 320 (or the host processor server with which the CDD 320 communicates), the computer system of the service provider 340, or a computer system of another financial institution may communicate with one or more financial institutions 350 over one or more EFT networks, such as one or more interbank networks or other proprietary networks that transmit financial information and to which access is restricted.

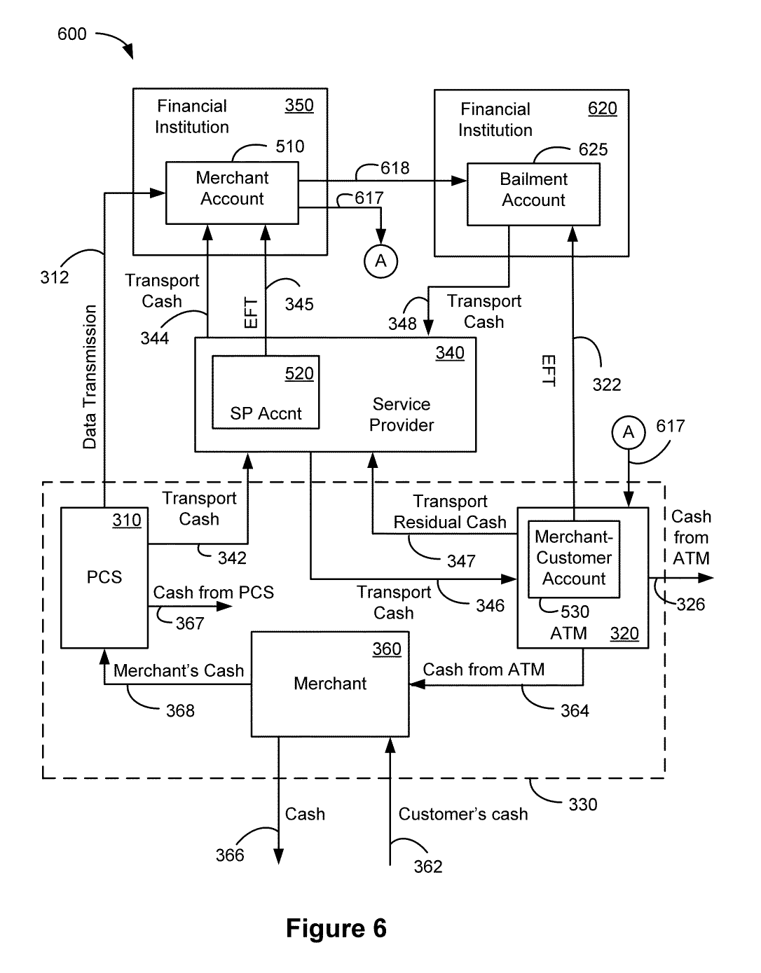

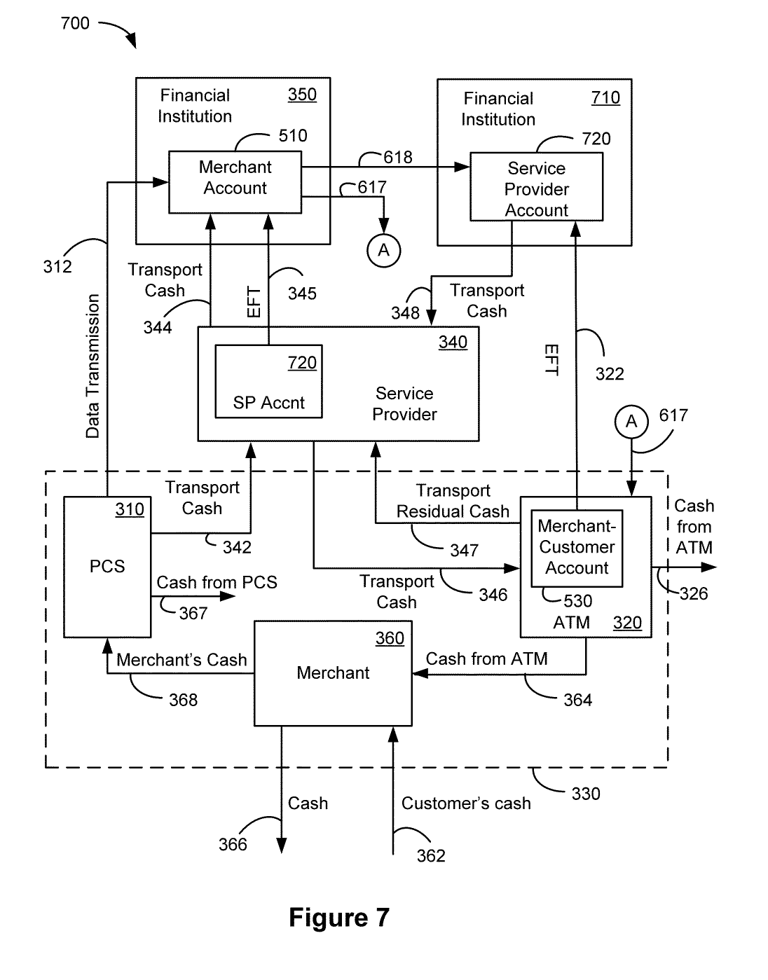

Vault cash or other dispensable currency is transported 346 to the merchant location 330 and is inserted into the ATM 320 or other CDD during a site visit. The vault cash may be transported 346 by the service provider 340 itself or by a courier service that is operated or contracted by the service provider 340. The vault cash may include cash from the financial institution 350 (e.g., cash that is drawn and transported 348 from the financial institution 350), cash from the CRD 310 (or a CRD of another merchant) that was set aside to replenish the CDD 320 at the merchant location 330 during a subsequent site visit, or a combination thereof. For example, if $30,000 should be transported 346 to the CDD 320, the service provider 340 may determine whether it has $30,000 in cash from the CRD 310 that was set aside to replenish the CDD 320 at the merchant location 330 during a subsequent site visit. If so, the service provider 340 transports 346 to the merchant location 330 the $30,000 in cash that was removed from the CRD 310 and set aside to replenish the CDD 320. If the service provider 340 has less than $30,000 in cash from the CRD 310 that was set aside to replenish the CDD 320, the service provider 340 may determine to withdraw $30,000 from the financial institution 350 and transport 348 from the financial institution 350 the $30,000. Then, the service provider 340 transports 346 the $30,000 to the merchant location 330 and inserts the $30,000 into the CDD 320. The $30,000 withdrawn from the financial institution 350 may be drawn from a merchant account (which is described in more detail with reference to FIG. 5), drawn or borrowed from a bailment account (which is described in more detail with reference to FIG. 6), or drawn from a service provider account (which is described in more detail with reference to FIG. 7).

The service provider 340 also removes from the CRD 310 cash the merchant inserted into the CRD 310 (for transport 342 to the currency processing location). In other words, the service provider 340 inserts the vault cash into the CDD 320 and removes the PCS cash from the CRD 310 during the same site visit. In addition, the service provider 340 may also remove residual cash from the CDD 320 and transport 347 the residual cash to the currency processing location or service-provider location, such as a room of the service provider 340 for counting cash or processing EFTs. Thus, the service provider 340 may remove residual cash from the CDD 320, insert the vault cash into the CDD 320, and remove the PCS cash from the CRD 310 during the same site visit. The PCS cash and the residual cash are transported together to the currency processing location. The PCS cash and the residual cash may be inserted into separate bags or pouches so that the service provider 340 is able to determine how much cash was removed from the CRD 310 and how much residual cash was removed from the CDD 320 after the PCS cash and the residual cash are transported to the currency processing location or service-provider location.

The CDD 320 is configured to, in response to a request from a user to dispense a desired amount of cash, determine whether the user is authorized to receive the desired amount of cash and dispense the desired amount of cash if the user is authorized to receive the desired amount of cash. For example, the CDD may comprise an automated banking machine or an ATM. ATMs may be used to carry out transactions, such as cash withdrawals or dispensations, deposits, account transfers, bill payments, check cashing, issuing scrip, issuing money orders and other types of financial transactions. ATMs may include any number of components including a display, card reader (e.g., magnetic card reader, smart card reader, or barcode reader), printer, bill dispenser, safe or vault, processor, keypad, memory, and network interface. The various processes and procedures by which an ATM determines (e.g., via an EFT network) whether a user is authorized to receive a desired amount of cash and dispenses the desired amount of cash if the user is authorized to receive the desired amount of cash is known to skilled persons. For example, as directed by a display, the user places a financial institution issued ATM card into a card reader and uses a keypad to enter a personal identification number (PIN), password, or other code. Once the ATM has verified the identity of the user using an EFT network accessed via a network interface (e.g., a modem), the user may access funds being stored in the user's bank account. The user may deposit money into and/or withdraw money from the user's bank account. Withdrawn money is immediately dispensed by a bill dispenser as cash.

Suitable ATMs include, for example, the RL1600 and RL2000 series offered by Triton of Long Beach, Miss.; the G1800 and GT3000 series offered by GenMega, Inc. of Fremont, Calif.; or the NH 15000 and NH 1800 series offered by Nautilus Hyosung of Coppell, Tex. The CDD may also comprise the currency dispense and control system described in U.S. Pat. No. 7,726,557.

When a user of the CDD 320 withdraws cash from the CDD 320 (e.g., to pay 364 the merchant 360 for goods or services or to take 326 from the merchant location 330 for another purpose), the CDD 320 (or a host processor with which the CDD 320 communicates) may cause a transfer 322, such as an EFT or ACH transfer, to be made from a bank account associated with the user to a bank account associated with the CDD 320. For example, if the vault cash within the CDD 320 is the merchant's cash, a transfer 322 is made from the bank account associated with the user to a bank account associated with the merchant 330 (see, e.g., FIG. 5). By way of another example, if the vault cash within the CDD 320 is the service provider's cash, a transfer 322 is made from the bank account associated with the user to a bank account associated with the service provider 340 (see, e.g., FIG. 7). By way of still another example, if the vault cash within the CDD 320 is the financial institution's cash, a transfer 322 is made from the bank account associated with the user to a bailment account (see, e.g., FIG. 6).

The user of the CDD 320 may be a merchant-customer or a merchant-employee. For example, the merchant 330 may provide a merchant-employee with a merchant card and associated security code, such as a PIN, so that the merchant-employee may withdraw cash from the CDD 320 to pay winnings to a merchant-customer (e.g., if the merchant location 330 has gaming stations, such as video poker machines), fill the cash register, or pay for goods or services received (e.g., COD).

The merchant card and the functionality it provides differ from that of a standard ATM card. For example, the merchant-employee using the merchant card may be able to withdraw $200 to $800 per transaction, and $10,000 or more per day, whereas a user of a standard ATM card may be limited to withdrawing $500 or less per day. In addition, the merchant card may function only with the CDD 320 at the merchant location 330 (or a CDD associated with another merchant-location, such as if the merchant has a chain of convenience stores). In other words, the merchant card may be associated with certain terminal identification numbers (TIDs). The merchant card may be issued to the merchant 360 at the direction or request of the service provider 340. For example, the service provider 340 may request a merchant card and give the merchant card to the merchant 360 so that the merchant card can be used at the CDD 320 to withdraw cash to pay winnings to a merchant-customer, fill the cash register, or pay for goods or services received (e.g., COD). Additionally, as described in U.S. Pat. No. 7,726,557, the merchant card affords time-release dispensation functionality and PIN-activated duress dispensation alerts.

According to one embodiment, the merchant card allows cash to be withdrawn from the CDD 320 independently of any EFT network, such as an interbank network. The merchant card may include a magnetic stripe, optical code (e.g., bar code), radio frequency identification circuit, or a memory chip on a smart card for storing a card number and possibly security information. In the case of a magnetic stripe, the card number may include one or more of an issuer identifier number (IIN), a bank identifier number (BIN), a merchant account number, and a checksum digit.

According to one embodiment, a merchant-employee withdraws cash from the CDD 320 using the merchant card. For example, after winning $335 at a gaming station at the merchant location 330, such as an on-site video poker machine, a merchant-customer presents to the merchant-employee a cash slip that was printed by the gaming station and includes an indication of the amount of the merchant-customer's winnings. After verifying the winnings (e.g., by scanning a barcode on the cash slip), the merchant-employee uses the merchant card to withdraw $320, for example, from the CDD 320. The merchant-employee withdraws the remaining $15 from the cash register, for example, and pays the merchant-customer his winnings of $335. By way of another example, the merchant-employee uses the merchant card to withdraw $340 from the CDD 320, pays the merchant-customer his winnings of $335, and places the remaining $5 in the cash register.

According to another embodiment, a merchant-customer withdraws cash from the CDD 320 using the merchant card. For example, after winning $335 at a gaming station at the merchant location 330, the merchant-customer presents to the merchant-employee a cash slip (or a payout slip or other voucher) that was printed by the gaming station and indicates the amount of the merchant-customer's winnings. After verifying the winnings (e.g., by scanning a barcode on the cash slip), the merchant-employee initiates a transfer of an amount of money equal to or approximately equal to the merchant-customer's winnings to an account associated with the merchant card. For example, the merchant-employee may access or log into (e.g., input an appropriate user name and password) a computer system associated with the service provider 340. The merchant location 330 may include a computing device, such as a POS terminal, general-purpose computer, smart phone, or other suitable device, in communication (e.g., via a wired or wireless network) with the computer system associated with the service provider 340. After accessing the service provider's computer system using the computing device, the merchant-employee inputs a card number of the merchant card (e.g., a sixteen-digit card number included on the face of the merchant card) and an amount of money to transfer to the account associated with the merchant card (e.g., the service provider's computer system prompts the merchant-employee to input the card number and amount of money to transfer). The amount of money is approximately equal to the merchant-customer's winnings and divisible by the bill denomination dispensable by the CDD 320 (e.g., if the smallest denomination bill that the CDD 320 dispenses is $20, the merchant-employee may transfer $320 or $340 to an account associated with the merchant card). The merchant-employee may input the card number in any suitable manner. For example, the merchant-employee may manually input the card, swipe the card through a card reader, such as a card reader integrated into a keyboard of the POS terminal, or use another input device (e.g., an image capture device that captures an image of the merchant card so that software operating on the computing device can recognize the card number or decode a barcode on merchant card).

After the merchant-employee initiates the transfer of the desired amount of money to the account associated with the merchant card (e.g., by inputting the card number and transfer amount into the service provider's computer system), the service provider's computer system effects a transfer for the amount of money input by the merchant-employee. According to one embodiment, the transfer is effected independently of any EFT network, such as an interbank network. For example, the service provider's computer system may include a storage device containing data records associating various merchant cards to maximum transaction amounts and authorized terminal identifications (e.g., a terminal identification associated with the CDD 320). The service provider's computer system may effect the transfer by updating the maximum transaction amount associated with the merchant card (e.g., the merchant card associated with the card number input by the merchant-employee). According to another embodiment, the transfer is effected using an EFT network. For example, the service provider's computer system may initiate an electronic transfer, such as an EFT or ACH transfer, to the account associated with the merchant card.

After the merchant-employee initiates the transfer of the desired amount of money to the account associated with the merchant card, the merchant-employee gives the merchant card to the merchant-customer. The merchant-employee also tells the merchant-customer the amount of money that was transferred to the merchant card and the PIN associated with the merchant card, and asks the merchant-customer to return the merchant card after the merchant-customer withdraws his winnings using the CDD 320. To encourage the merchant-customer to return the merchant card, the merchant-employee may transfer to the merchant card an amount of money that is less than the merchant-customer's winnings. For example, if the merchant-customer won $335, the merchant-employee may transfer $320 to the merchant card and tell the merchant-customer that they will receive the remaining $15 (e.g., paid from the cash register) after the merchant-customer returns the merchant card to the merchant-employee. After the merchant-employee gives the merchant card to the merchant-customer, the merchant-customer uses the merchant card to withdraw the amount of money that was transferred to the card (e.g., $320). For example, the merchant-customer may swipe the merchant card at the CDD 320, enter the PIN, and enter the amount of money that was transferred to the card (e.g., $320). After the CDD 320 dispenses the amount of money that was transferred to the merchant card (e.g., $320), the merchant-customer returns the merchant card to the merchant-employee and the merchant-employee gives the merchant-customer the difference between the amount of money transferred to the card and the merchant-customer's winnings (e.g., $15) from the cash register. The difference between the amount of money transferred to the card and the merchant-customer's winnings may be between $0.99 to $19.99 (typically less than the smallest bill denomination of the dispenser), for example.

The CDD 320 may process a transaction associated with the merchant card independently of any EFT network or using an EFT network, such as an interbank network or another proprietary network that transmits financial information and to which access is restricted. For example, the CDD 320 may comprise a currency dispense and control system described in U.S. Pat. No. 7,726,557. By way of another example, a computer system associated with the service provider 340 may comprise or implement the currency dispense and control systems and methods described in U.S. Pat. No. 8,332,321, which is hereby incorporated by reference in its entirety. An example of processing a transaction associated with the merchant card independently of any EFT network may include one or more of the following steps. Initially, a request to dispense currency is received from a merchant-employee or merchant-customer via the CDD 320. For example, a merchant-employee or merchant-customer may swipe or insert the merchant card (or a standard ATM card) into the CDD 320 so that the CDD 320 can capture the card number (or at least some portion of it). The CDD 320 may then prompt the user (or customer) for their PIN and the transaction amount.

The request to dispense currency may be sent to a remote processor, such as a computer system of the service provider 340, a transaction processor, or a switch. For example, the CDD 320 may send all or a portion of the information it collected and/or has stored (e.g., its identification number, such as a terminal identification number) to the remote processor via a data link. The data sent to the remote processor may include one or more of the transaction amount, a terminal identification, card data (e.g., the account number), a PIN, the date, and the time. After receiving the request to dispense currency, the remote processor determines whether, based on the card data, the request requires authorization from a financial institution via an EFT network. For example, after receiving the request, the remote processor may compare the account number of the merchant card to the card data stored in a storage device in communication with the remote processor. If the remote processor does not find the account number stored locally (e.g., the remote processor may include a storage device containing data records), it may assume that the request requires authorization via an EFT network. By way of another example, the user may provide an indication that they want to use time release safe functionality, such as by pressing a time release safe button on the CDD 320 or responding to a prompt provided via the CDD 320.

If the request requires authorization via an EFT network, the request is transmitted to an appropriate EFT network. For example, the remote processor may identify the proper network or financial institution based on information retrieved from the CDD 320 and relay the appropriate information to an appropriate financial institution via one or more of the EFT networks. The financial institution may verify the user's account data, PIN, and whether the user has sufficient funds available for the transaction amount. The financial institution may also transmit an indication of an authorization or denial to the remote processor (e.g., a message indicating that the request has been authorized or denied). The remote processor may then transmit the indication of the authorization or denial to the CDD 320. The CDD 320 may then either dispense the cash or communicate the denial.

If the request does not require authorization via an EFT network, the request is compared to a database of records authorizing currency dispensations. For example, the remote processor may include a storage device containing data records associating various merchant cards to authorized terminal identifications and maximum transaction amounts. The remote processor may compare the received merchant card data (e.g., the account number) to records in the database to determine whether the request is authorized. For example, the remote processor may ensure that the merchant card is authorized for use on the CDD 320 and ensure that the transaction amount does not exceed a maximum transaction amount (e.g., an amount of money that was transferred to the merchant card). The remote processor may also place daily limits and per transaction limits on the amount of money that can be withdrawn using the merchant card. The remote processor transmits an indication of an authorization or denial to the CDD 320, which either dispenses the currency or communicates the denial to the merchant-employee or merchant-customer.

According to one embodiment, the remote processor generates a time delay, such as a time delay between dispensations, a pre-dispensation delay, a post dispensation delay, or a combination thereof. For example, the remote processor may ensure that sufficient time has elapsed between successive transactions if the merchant card has been recently used to dispense cash. The remote processor may delay the transmission of the authorization for a predetermined period of time or may simply wait a predetermined period of time before dispensing cash. For example, the remote processor may enter a delay period and after the expiration of the delay period, the remote processor may transmit the authorization and/or request the user to re-swipe the merchant card and reenter the PIN before dispensing the cash.

If the user of the CDD 320 is a merchant-employee or merchant-customer using the merchant card, a transfer 322 may be made from a bank account associated with the merchant card, such as a bank account associated with the merchant 330. The merchant's account may be debited transaction-by-transaction or once at the end of the business day for a total amount dispensed that day. If the user of the CDD 320 is a merchant-customer using a standard ATM card, a transfer 322 may be made from the bank account associated with the merchant-customer. Each time a merchant-employee or merchant-customer withdraws cash using the merchant card, the service provider 340 may receive a transaction fee, such as $1 to $5 (e.g., the service provider may send the merchant a monthly bill that indicates the number of transactions performed since the last bill along with the service fee for those transactions). In addition, or alternatively, the service provider 340 may charge the merchant a monthly service fee for providing the functionality associated with the merchant card.

The CDD 320 (or a host processor with which the CDD 320 communicates) may optionally transmit 324 to a computer system of the service provider 340 (or the host processor) an indication of the amount of cash that the merchant-employee or merchant-customer withdrew. The optional transmission 324 may, for example, help the service provider 340 determine when to service the CDD 320 (e.g., transport to and insert cash into the CDD 320).

FIG. 3B is a block diagram illustrating a system 370 for servicing one or more CDDs (e.g., ATM 320) and one or more CRDs (e.g., PCS 310) disposed at multiple merchant locations (e.g., merchant locations 330a through 330n), according to one embodiment. The system 370 is similar to the system 300 described with reference to FIG. 3A but the system 370 illustrates the service provider 340 servicing CDDs and CRDs disposed at a plurality of merchant locations. In FIG. 3B, reference numerals 310, 320, 340, 342, 344, 346, 347, 348 and 360 indicate elements similar or identical to those of the same name and reference numeral that were described with reference to FIG. 3A. The system 370 includes a plurality of merchant locations 330a through 330n. Each of the merchant locations 330a through 330n may include one or more CRDs (e.g., PCS 310) and one or more CDDs (e.g., ATM 320).

As described with reference to FIG. 3A, dispensable cash is transported 346 to one or more of the merchant locations 330a through 330n for insertion into the CDD 320 during a site visit to the merchant location. During the site visit, the dispensable cash is inserted into the CDD 320. In addition, during the same site visit, the service provider 340 removes from the CRD 310 merchant cash that was inserted into the CRD 310 over a period of time by a merchant or merchant-employee. After removing the merchant cash, the service provider 340 transports 342 the cash to a currency processing location to process the merchant cash removed from the CRD 310. After transporting 342 the merchant cash to the currency processing location, the service provider 340 may allocate a portion of the cash from the CRD 310 to be physically transported 344 to the financial institution 350 (e.g., the financial institution associated with the merchant location from which the merchant cash was removed). The remainder of the cash from the CRD 310 may be set aside to replenish the CDD 320 at the merchant location 330a (or a CDD of another merchant, such as merchant location 330b through 330n) during a subsequent site visit. The service provider 340 also causes (e.g., via a service provider computer system 372) an EFT 345 in the amount of the remainder to be made from a bank account of the service provider 340 to the financial institution 350. According to one embodiment, the merchant locations 330a through 330n may utilize a common financial institution 350 (at least for purposes of the CRD 310) and the service provider 340 may transport 344 cash to a single financial institution. According to another embodiment, the merchant locations 330a through 330n may utilize different financial institutions, in which case the service provider 340 may transport 344 cash to multiple financial institutions.

The service provider 340 has associated therewith one or more service provider computer systems 372 and one or more vehicles 374. The one or more vehicles 374 are used to transport cash to and from the merchant locations (e.g., merchant locations 330a through 330n), the currency processing location, and the financial institution(s). The vehicles 374 may be owned and operated by the service provider 340 itself or by a courier service that is operated or contracted by the service provider 340.

The service provider computer system 372 includes any number of components, such as one or more of a display driver, a display, a processor, an input/output controller, an input device, a memory, a memory interface, a storage device, a network interface, a cash counter, a printer controller, and a printer. The service provider computer system 372 may be suitably programmed to send data to and receive data from one or more CRDs 310 (e.g., that are disposed at one or more of the merchant locations 330a through 330n) via data link 380, one or more CDDs 320 (e.g., that are disposed at one or more of the merchant locations 330a through 330n) via data link 382, one or more financial institutions 350 via data link 384, one or more merchants 360 associated with the merchant locations 330a through 330n via data link 386 (e.g., via a merchant computer system, which may include a computer, server, storage device, and/or database), and one or more courier services or armored car companies 376 via data link 388. The service provider computer system 372 may communicate (e.g., via a network interface) with any of the CRDs 310, the CDDs 320, the financial institutions 350, the merchants 360, or the courier services 376 using any suitable communications network, such as the communications networks described with reference to FIG. 3A. According to one embodiment, the data links 380, 382, 384, 386, and 388, do not comprise EFT networks, such as an interbank networks. In other words, the service provider computer system(s) 372 may communicate with one or more of the CRD(s) 310, the CDD(s) 320, the financial institution(s) 350, the merchant(s) 360, and the armored car company(s) 376 without using any EFT networks. The service provider computer system(s) 372 may instead communicate over data links 380, 382, 384, 386, and 388 via a suitable public network, such as the Internet.

The service provider computer system 372 may be suitably programmed to determine the amount of collected cash to physically transport 344 to the financial institution 350 and the amount of collected cash that is set aside to replenish one or more CDDs (e.g., CDDs disposed at merchant locations 330a through 330n). In addition, the service provider computer system 372 may be configured to cause one or more armored couriers 374 to transport to one or more merchant locations (e.g., merchant locations 330a through 330n) dispensable cash for insertion into the CDD 320 (e.g., send instructions or a message to service provider personnel or courier service personnel), instruct service provider personnel or courier service personnel to insert the dispensable cash into the CDD 320, instruct service provider personnel or courier service personnel to remove merchant cash from the CRD 310, and instruct service provider personnel or courier service personnel to transport to a currency processing location for processing the merchant cash removed from the CRD 310.

The CRD 310 disposed at merchant location 330a (or another merchant location, such as any of the merchant locations 330b through 330n) transmits to the service provider computer system 372 via data link 380 an indication of the amount of cash that is stored within the CRD 310. After receiving the transmission, the service provider computer system 372 transmits to a financial institution associated with the merchant (e.g., financial institution 350) via data link 384 an indication of the amount of cash that is stored within the CRD 310 so that the financial institution may credit the merchant's bank account for all or a portion of the cash stored within the CRD 310.

In addition to transporting vault cash to the merchant location 330a (or another merchant location, such as any of the merchant locations 330b through 330n) and inserting the vault cash into the CDD 320, the service provider 340 may facilitate processing requests from a user to dispense cash from the CDD 320. For example, when a user (e.g., a merchant-customer or merchant-employee) of the CDD 320 initiates a request to dispense a desired amount of cash, the CDD 320 may transmit (via data link 382) the request to the service provider computer system 372. The service provider computer system 372 may then transmit (via data link 390, which may be an EFT network) the request to an appropriate financial institution, such as financial institution 350, to determine whether the user is authorized to receive the desired amount of cash. The service provider computer system 372 may identify the appropriate EFT network and/or financial institution based on information retrieved from the user's card and relay the appropriate information to the financial institution via one or more EFT networks, such as one or more interbank networks or other proprietary networks that transmit financial information and to which access is restricted. The financial institution may then verify the user's account data and verify whether the user has sufficient funds available for the desired amount of cash. The financial institution then transmits an indication of an authorization or denial to the service provider computer system 372 (e.g., a message indicating that the request has been authorized or denied). The service provider computer system 372 then transmits (via data link 382) the indication of the authorization or denial to the CDD 320. The CDD 320 then either dispenses the desired amount of cash (if the user is authorized to receive the desired amount of cash) or communicates the denial to the user. The service provider computer system 372 may also process a request to dispense cash independently of an EFT network. For example, one or more of the computer systems 372 may comprise or implement the currency dispense and control systems and methods described in U.S. Pat. No. 8,332,321.

One or more merchants 360 or merchant computer systems associated with the merchant locations 330a through 330n may communicate (via a wired or wireless data link 386) with the service provider computer system 372 to allow, for example, a merchant to access data associated with the merchant. For example, the merchant may log into the service provider computer system 372 to determine how much cash has been inserted into the CRD 310, the number of bills inserted by denomination (e.g., the number of $1 bills, $5 bills, $10 bills, etc.), and a banknote level indication (e.g., 80% full), which may help optimize courier pickups and reduce operating costs. In addition, or alternatively, the service provider computer system 372 may send status updates to the merchant (e.g., daily emails indicating how much cash is within the CRD 310). The merchant may also be able to access historical data concerning the CRD 310 and the CDD 320, such as a history of how much cash has been inserted into the CRD 310 and how much cash has been withdrawn from the CDD 320. A merchant or merchant-employee may communicate with the service provider computer system 372 using any suitable device, such as a general-purpose computer, personal computer, or other device (e.g., mobile phone or smart phone).

One or more financial institutions 350 or financial institution computer systems may communicate (via data link 384) with the service provider computer system 372 to allow, for example, a financial institution to determine how much cash has been inserted into the CRD 310. The financial institution may also be able to access historical data concerning the CRD 310 and the CDD 320, such as a history of how much cash has been inserted into the CRD 310 and how much cash has been withdrawn from the CDD 320.

One or more courier services or armored car companies 376 or their computer system(s) may communicate (via data link 388) with the service provider computer system 372 to allow, for example, the courier service to determine when to withdraw merchant cash from the CRD 310 and insert vault cash into the CDD 320. In addition, or alternatively, the service provider computer system 372 may send an indication to the courier service 376 that the courier service should withdraw merchant cash from the CRD 310 and/or insert vault cash into the CDD 320 (e.g., via email). According to one embodiment, the CRD 310 is configured to send a request for service (e.g., a request for a site visit to remove currency) to the armored car company computer system and/or the service provider computer system 372 after the amount of currency within the CRD 310 exceeds a predetermined level. For example, the CRD 310 may send a request for service after it is 80% full so that the armored car company can make a site visit to the merchant location and empty the CRD 310. The CDD 320 may also be configured to send a request for service (e.g., a request for a site visit to insert vault cash) to the armored car company computer system and/or the service provider computer system 372 after the amount of currency within the CDD 320 falls below a predetermined level. For example, the CDD 320 may send a request for service after it is only 20% full so that the armored car company can make a site visit to the merchant location and insert additional vault cash into the CDD 320.

FIG. 4 is a flow diagram illustrating a method 400 of servicing a CRD, such as the PCS 310, and a CDD, such as the ATM 320, according to one embodiment. Initially, the CDDs and CRDs are provided at a merchant location. For example, the service provider may transport and install the CRD 310 and the CDD 320 in the merchant location. At step 410, vault cash or other dispensable currency is transported to a merchant location for insertion into a CDD, such as an ATM. The vault cash may be transported to the merchant location in various ways. For example, armored courier personnel may drive an armored vehicle having vault cash stored therein to the merchant location. The personnel may be employed by the service provider or the service provider may contract out the step of transporting the vault cash to the merchant location. In other words, the vault cash may be transported by the service provider itself or by a courier service that is operated or contracted by the service provider. In addition, the personnel may be employed by the merchant (e.g., merchant-employees) or the merchant may contract out the step of transporting the vault cash to the merchant location. According to one embodiment, a courier or message service is used to transport the vault cash to the merchant location. The vault cash may include cash from a financial institution (e.g., cash that is transported from a financial institution), cash from a CRD, such as a PCS, that was set aside to replenish the CDD at the merchant location during a subsequent site visit, or a combination thereof.

During the site visit, the CDD is serviced (e.g., by the service provider or the courier service) as represented by step 420. For example, the personnel may insert the vault cash into the CDD to replenish the amount withdrawn by ATM users since the last servicing. The personnel may also remove any residual vault cash (e.g., vault cash that was previously inserted into the CDD but was not withdrawn by a user of the CDD). For example, if the CDD utilizes cash canisters to hold the vault cash, the service provider may remove cassette(s) that contain unused vault cash and insert into the CDD a new cassette that is filled with new vault cash.

During the same site visit, the CRD is also serviced (e.g., by the service provider) as represented by step 430. For example, the personnel may remove from the CRD merchant cash (e.g., PCS cash) that was inserted into the CRD over a period of time by the merchant. According to one embodiment, the service provider or a contractor of the service provider removes the merchant cash from the CRD. If the CRD incorporates a drop box (e.g., for currency that could not be read by the currency counter of the CRD), the service provider may also remove the contents of the drop box and transport those contents to a currency processing location or directly to a financial institution. Steps 420 and 430 may be performed in any order or at the same time.

At step 440, the merchant cash that was removed from the CRD is transported to a currency processing location or directly to a financial institution. For example, after the service provider has completed a site visit, the service provider may transport the cash collected from the CRD to a currency processing location, such as a room of the service provider for counting cash or processing EFTs. In addition, the service provider may also transport the residual cash removed from the CDD to the currency processing location for processing. According to one embodiment, the merchant cash removed from the CRD is transported directly from the merchant location to the financial institution (e.g., without stopping at a currency processing location). The merchant cash may be transported to the currency processing location in various ways. For example, armored courier personnel may drive an armored vehicle having the merchant cash stored therein to the currency processing location. The personnel may be employed by the service provider or the service provider may contract out the step of transporting the merchant cash to the currency processing location. In other words, the merchant cash may be transported by the service provider itself or by a courier service that is operated or contracted by the service provider. According to one embodiment, a courier or message service may be used to transport the merchant cash to the currency processing location or other location (e.g., a financial institution).

After step 440, the service provider may optionally process the collected cash (e.g., the merchant cash removed from the CRD and any residual cash) as described in more detail below. In addition, or alternatively, the service provider may make a site visit to another merchant location to perform steps 410-440 or may make another site visit to the same merchant (e.g., a few days, weeks, or months later).

The collected cash (e.g., the merchant cash removed from the CRD and any residual cash) may be processed in various manners at the currency processing location. For example, all of the cash collected from a particular merchant may be set aside to be transported to an appropriate financial institution (e.g., the merchant's financial institution). By way of another example, a portion of the cash collected from a particular merchant may be set aside to be transported to an appropriate financial institution (e.g., the merchant's financial institution). The remainder of the collected cash may then be set aside to replenish a CDD (e.g., at the merchant's location or at another merchant's location) during a subsequent site visit. An electronic or automated transfer of funds, such as an EFT or ACH transfer, in the amount of the remainder of the collected cash is made from an account of the service provider to an appropriate financial institution (e.g., the merchant's financial institution). Because the merchant's financial institution may have previously extended credit to the merchant for the cash that the merchant inserted into the CRD, the merchant's financial institution may offset the transported cash and the EFT against the credit financial institution previously extended the merchant.

The financial institution to which the collected cash is physically transported or electronically transferred may depend on the source of the collected cash. For example, if the collected cash (or a portion thereof) is merchant cash removed from a CRD at a merchant location, the service provider may physically transport or electronically transfer the collected cash (or a portion thereof) to a financial institution associated with the merchant (e.g., the financial institution that extended credit to the merchant for the merchant cash that the merchant inserted into the CRD). By way of another example, if the collected cash (or a portion thereof) is residual cash from a CDD, the service provider may physically transport or electronically transfer the collected cash (or a portion thereof) to a financial institution associated with the owner of the residual cash.

After step 440, a determination may be made as to how much of the collected cash should be physically transported to a financial institution and how much of the collected cash should be used to replenish the CDD at the merchant location (or the CDD of another merchant) during a subsequent site visit. The service provider may consider several factors when determining how much cash to physically transport to the financial institution and how much cash to set aside to replenish the CDD at the merchant location (or the ATM of another merchant) during a subsequent site visit. One factor may be the denominations of cash represented in the collected cash. For example, the service provider may keep certain denominations of cash (e.g., $20 bills, $10 bills, or $5 bills). Another factor may be the quality of the bills in the collected cash. For example, the service provider may keep crisper bills (e.g., to reduce bill jams in the CDD) and transport worn or torn bills to the financial institution.

Still another factor may be the amount of money the service provider has available in one or more of its bank accounts or a third party bailment account to transfer to the financial institution. Yet another factor may be the amount of time the financial institution gave the merchant, the service provider, or both, to physically transport the cash to the financial institution. For example, the financial institution may start charging interest on the credit it extended to the merchant after a certain period of time (e.g., a few weeks) if the cash is not physically transported to the financial institution beforehand. Still another factor may be the spread between the interest rate the financial institution charges the merchant for not delivering the cash on time and the interest rate the financial institution charges the service provider for money the service provider borrows to fill the CDD. For example, the service provider may be better off returning the cash late instead of borrowing cash from the financial institution to fill the CDD. In some instances, it is possible for the service provider, the merchant, or both, to essentially use the collected cash interest free for a period of time. Additionally, banks may be able to use cash in safes as part of their bank reserve amounts.

Yet another factor may be the cost of obtaining the vault cash and transporting the vault cash to the merchant location. For example, the service provider may factor in how much it will cost to borrow the vault cash from a financial institution and how much it will cost to physically transport the vault cash (e.g., the amount of time it will take to transport the vault cash from the financial institution to the merchant location and the distance to the merchant location). The service provider may also factor in whether the transportation costs can be spread among several merchant locations. For example, the service provider may service during one trip several merchant locations that are within a certain distance from each other, which may help lower the total transportation costs by reducing unnecessary trips to remote locations (e.g., especially if those merchants are located far away from the currency processing location). The service provider may attempt to balance the cost of borrowing the vault cash, the cost of transporting the vault cash, and the amount of cash that the CDD is expected to dispense over a period of time (e.g., how much the CDD has historically dispensed of a period of time). In other words, while the service provider does not want the CDD to run out of cash between site visits, the service provider may also want to minimize its borrowing costs for the vault cash and minimize the number of site visits to the merchant location. If, for example, a CDD has historically dispensed $30,000 per month, the service provider may include a buffer of $6,000 to help ensure that the CDD does not run out of vault cash between site visits. The service provider may then balance the cost of each site visit against the cost of borrowing a sufficient amount of cash to ensure that the CDD will be able to dispense approximately $36,000 per month (e.g., the service provider may determine that it is more cost effective to make multiple site visits and borrow less vault cash between visits rather than making a limited number of site visits and borrowing more vault cash between visits).

The ratio between the amount of collected cash to physically transport to the financial institution and the amount of collected cash to set aside to replenish the CDD at the merchant location (or the ATM of another merchant) during a subsequent site visit may vary. For example, the service provider may determine to physically transport 100% of the collected cash to the financial institution. By way of another example, the service provider may determine set aside 100% of the collected cash to replenish a CDD during a subsequent site visit. According to one embodiment, the service provider may physically transport approximately 20% to approximately 40% of the collected cash to the financial institution. For example, if the service provider removes $10,000 from the CRD at a merchant location, the service provider may physically transport approximately $2,000 to approximately $4,000 of the collected cash to the financial institution. If the service provider transports $2,000 of the collected cash to the financial institution, the service provider may set aside approximately $8,000 of the collected cash to replenish a CDD during a subsequent site visit.

The determination of the amount of collected cash to physically transport to a financial institution and the amount of collected cash that is set aside to replenish a CDD may be made by service provider personnel or a service provider computer system, such as the service provider computer system 372 illustrated in FIG. 3B. For example, the processing location may include a computer or computing system that is suitably programmed to determine the amount of collected cash to physically transport to a financial institution and the amount of collected cash that is set aside to replenish a CDD. The computer system may be configured to cause the service provider (e.g., send instructions or a message to the service provider) to transport to the merchant location dispensable cash for insertion into the CDD, insert into the CDD the dispensable cash, remove from the CRD merchant cash, and instruct the service provider to transport to a currency processing location for processing the merchant cash removed from the CRD.

Data, such as the data used by the computer system to determine the amount of collected cash to physically transport to a financial institution and the amount of collected cash to set aside to replenish a CDD at a merchant location during a subsequent site visit, may be input into the computer system in any number of ways. For example, the data may be input manually (e.g., by service provider personnel) or the computer system may be programmed to obtain the data from a data feed or data source. In other words, data concerning the factors used to determine the ratio between the amount of collected cash to physically transport to a financial institution and the amount of collected cash to set aside to replenish a CDD during a subsequent site visit may be input manually into the computer system or may be obtained automatically by the computer system.

For example, service provider personnel may insert the collected cash into a cash counter associated with the computer system (e.g., coupled to the computer system). The cash counter may then count the cash and output to the computer system the total amount of collected cash and cash denomination data. In addition, the cash counter may be configured to determine bill quality (e.g., using known techniques, such as optically scanning the bills) and separate low quality bills for transport to a financial institution. Further, the cash counter may be configured to check for counterfeit bills. The computer system may receive data from a data feed or data source (e.g., via the network interface). For example, one or more CRDs may transmit (e.g., daily or after cash is inserted into the CRD) to the computer system an indication of the amount of cash that is stored within the respective CRD. The computer system may be programmed to keep a running total of the amount of cash that is stored within the respective CRD. After the service provider makes a site visit to remove from the CRD the merchant cash and transports the removed cash to the currency processing location, the computer system may use the running total to determine the amount of cash collected from the CRD. In addition, the cash counter may be used to verify that the running total matches the amount of cash that was removed from the CRD.

One or more CDDs (or a host processor with which a CDD communicates) may transmit (e.g., daily or each time cash is dispensed) to the computer system an indication of the amount of cash that the CDD user withdrew. The computer system may be programmed to maintain historical usage data regarding how much cash a CDD dispenses over a period of time (e.g., over a month). The historical usage data may be used by the computer system in determining the amount of collected cash to physically transport to a financial institution and the amount of collected cash to set aside to replenish a CDD during a subsequent site visit.

The computer system may also obtain other data from a data feed or data source concerning the factors that may be used to determine the ratio between the amount of collected cash to physically transport to a financial institution and the amount of collected cash to set aside to replenish a CDD during a subsequent site visit. For example, the computer system may obtain data (e.g., via the network interface) regarding the amount of money the service provider has available in one or more of its bank accounts (or a third party bailment account) to transfer to the financial institution, the amount of time the financial institution gave the merchant, the service provider, or both, to physically transport the cash (from a CRD) to the financial institution, the cost of obtaining the vault cash for insertion into a CDD (e.g., current interest rates), or the cost of transporting the vault cash to the merchant location. In addition, one or more CDDs or one or more CRDs may transmit to the computer system an indication that a CDD or CRD should be serviced soon (e.g., vault cash should be inserted into the CDD or merchant cash should be removed from the CRD).

The computer system may use the various input data to determine the ratio between the amount of collected cash to physically transport to a financial institution and the amount of collected cash to set aside to replenish a CDD during a subsequent site visit. After determining the ratio, the computer system may output the ratio in various manners. For example, the computer system may output the ratio to a display coupled to the computer system. By way of another example, the computer system may output the ratio to a printer coupled to the computer system. By way of still another example, the cash counter may be configured to separate the cash into various stacks in response to the ratio determined by the computer system (e.g., a first stack to be returned to a financial institution, a second stack to be transported to a first CDD, and a third stack to be transported to a second CDD). The computer system may also be programmed to cause an EFT to be made to a financial institution in the amount equal to the collected cash that is set aside to replenish a CDD during a subsequent site visit. If, for example, the service provider removes $10,000 from the CRD, the computer system may determine (e.g., using any of the factors previously described) to physically transport $3,000 of the collected cash to the financial institution and set aside $7,000 of the collected cash to replenish a CDD during a subsequent site visit. The computer system may also initiate an EFT in the amount of $7,000 to be made from a bank account of the service provider to the financial institution.

After the collected cash (e.g., the merchant cash removed from the CRD and any residual cash) has been processed at the currency processing location, the service provider may make another site visit (to the same merchant location or another location) to service the CRD and CDD using the collected cash that was set aside during processing to replenish the CDD during a subsequent site visit (e.g., the “recycled cash”).

Although according to one embodiment the collected cash is transported from a merchant location to a different location for processing, the service provider may process the collected cash on-site (e.g., in the back of an armored vehicle). In addition, although according to one embodiment the service provider transports the collected cash to another location for processing after servicing a merchant location, the service provider could make site visits to multiple merchant locations before transporting the collected cash to another location for processing (in which case, the cash from each merchant location would be separately counted and set aside for deposit with a financial institution or for recycling). Further, certain merchant locations may include a plurality of CRDs, which may be configured in a daisy chain configuration. For example, a plurality of CRD slaves (e.g., installed proximate a point of sale) may communicate with a master CRD (e.g., an on-site master CRD), and provide the master CRD with an indication of how much cash has been inserted into each CRD. The master CRD may then transmit to an appropriate financial institution, the service provider, or both, an indication of how much cash has been inserted into the master CRD and each of the CRD slaves. During the site visit to the merchant location, the service provider may remove cash from master CRD and each of the CRD slaves. The master CRD may have located therein keys or other access control devices that allow the service provider to open the safes within the CRD slaves.

As should be apparent from the foregoing description of the system 300 and the method 400, a service provider may use some or all of the merchant cash removed from a CRD to replenish the vault cash within a CDD (which may have been placed at the merchant location by the service provider). In a typical week a merchant site may take in $20,000 in cash, for example. A quarter of that cash ($5,000) may come from customer withdrawals from the on-site CDD and three-quarters of that cash ($15,000) may come from the wallet/purses of the customers. After the merchant inserts or feeds (e.g., “deposits”) that cash into the CRD and the service provider removes that cash from the CRD during a site visit, the service provider may set aside half of the collected cash ($10,000) to replenish the CDD at the merchant location (or a CDD of another merchant) during a subsequent site visit (e.g., to fill the vault cash within the CDD). An amount equal to the cash removed from the CRD ($20,000) is physically or electronically transferred to a financial institution. For example, $10,000 may be physically delivered to the financial institution (to be deposited into a bank account associated with the merchant or offset against the credit the financial institution previously extended to the merchant) and the other $10,000 may be electronically transferred to the financial institution (to be deposited into a bank account associated with the merchant or offset against the credit the financial institution previously extended to the merchant).

As should be appreciated in view of the teachings herein, the system 300 and method 400 may offer certain advantages. For example, the system 300 and method 400 may help the merchant, the service provider, the financial institution, or a combination thereof, save cash-counting fees. The financial institution may, for example, charge 85¢ to $1.20 per $1,000 to count cash. Thus, a merchant with 40 locations may pay the financial institution approximately $3,000 to $5,000 per month to count deposit-cash. There typically are no fees or minimal fees associated with receiving electronic deposits (e.g., ACH transfers). Thus, if the service provider electronically transfers (e.g., from a bank account of the service provider to a bank account of the merchant) a portion of the cash that would otherwise have been physically delivered to the financial institution (e.g., $10,000 of the $20,000 PCS cash) the merchant can save the cash counting fees (which could amount to approximately $100 to $400 per month per site, for example).

By way of another example, the system 300 and method 400 may help the merchant save service fees for transporting cash from the merchant location to the financial institution. For example, high-volume merchants may have daily armored car pick-ups of cash for transport to the financial institution and may, for example, pay approximately $300-600 per month for the service. The system 300 and method 400 may allow the service provider to minimize the number of trips needed to the merchant location (e.g., the service provider may only need to service the merchant weekly or bi-weeks, which could save hundreds of dollars per month).

By way of yet another example, the system 300 and method 400 may help reduce the amount of cash (i.e., vault cash) needed to ensure that the CDD will not run out of cash between servicing. For example, lower-volume sites may have previously had site-visits to service the CDD once every one, two, or four weeks. Because the service provider is also servicing the CRD, it might be cost effective to make weekly site visits, which could reduce by 50% to 75% the amount of vault cash needed for the CDD (which would also reduce the cost of the bailment fees).

By way of still another example, the system 300 and method 400 may help the service provider reduce the amount of bailment fees incurred for borrowing cash to fill the CDD. For example, by taking the merchant cash from the CRD and recycling it to a CDD the service provider has placed at merchant location (or elsewhere), the service provider can reduce its monthly bailment fees (e.g., if the service provider pays the financial institution approximately $15,000 per month for bailment fees, the service provider may be able to cut its monthly bailment fees in half or more than half to approximately $7,500).

Referring now to FIGS. 5, 6, and 7, the cash flow within various systems will be described. In particular, the cash flow described with reference to FIG. 5 relates to using vault cash (e.g., cash within the CDD) belonging to the merchant 360, the cash flow described with reference to FIG. 6 relates to using vault cash belonging to the financial institution 620, and the cash flow described with reference to FIG. 7 relates to using vault cash belonging to the service provider 340.

FIG. 5 is a block diagram illustrating a system 500 for servicing the CRD 310 and the CDD 320 in which vault cash within the CDD belongs to the merchant 360. The system 500 is similar to the system 300 described with reference to FIG. 3A but the vault cash used to fill the CDD 320 is drawn from a merchant account 510 at the financial institution 350 and merchant cash from the CRD 310 is deposited into the account 510. In FIG. 5, reference numerals in the three hundreds (e.g., 310) indicate elements similar or identical to those of the same name and reference numeral that were described with reference to FIG. 3A (i.e., CRD 310).

The merchant 360 may deposit money into the merchant account 510 at any time. For example, the merchant 360 may prime the merchant account 510 by depositing $10,000 to $40,000 for each of the merchant's CDD 320 or for each merchant location. In other words, if the merchant 360 has two merchant locations, the merchant 360 may prime the merchant account 510 by depositing $20,000 to $80,000 into the merchant account 510. The amount of money the merchant 360 uses to prime the merchant account 510 may be based on several factors. For example, the amount of money the merchant 360 deposits into the merchant account 510 may be based on the historical transaction activity of the CDD 320 (e.g., how much cash the CDD 320 has historically dispensed per month). By way of another example, the amount of money the merchant 360 deposits into the merchant account 510 may be based on the amount of money one or more merchant-employees may withdraw from the CDD 320 to, for example, payout gaming machine winnings (e.g., if the merchant location 330 has gaming stations, such as video poker machines) or pay for goods or services received (e.g., a COD transaction). The money that the merchant 360 deposits into the merchant account 510 may come from various sources, such as another account, a cash deposit, or a wire transfer.

As previously described with reference to FIG. 3A, vault cash (or other dispensable currency) is transported 346 to the merchant location 330 and is inserted into the ATM 320 or other CDD during a site visit. The vault cash may be transported 346 by the service provider 340 itself or by a courier service that is operated or contracted by the service provider 340. The vault cash includes cash drawn from the merchant account 510 at the financial institution 350 and transported 348 from the financial institution 350. For example, personnel may periodically (e.g., once a week) drive an armored car to the financial institution 350 (e.g., a Federal Reserve Bank or Depot) and withdraw cash from the merchant account 510. The armored-car personnel may stop at a central location (e.g., a currency processing location) to allocate the cash that was withdrawn from the merchant account 510 for transport to multiple merchant locations. For example, if the merchant has three merchant locations and $30,000 was withdrawn from the merchant account 510, the armored-car personnel may allocate $10,000 for a first merchant location, $10,000 for a second merchant location, and $10,000 for a third merchant location. The armored car then transports the cash that was withdrawn from the merchant account 510 to the CDD 320 and the cash is inserted into the CDD 320 by the armored-car personnel.

During the same site visit, the armored-car personnel also remove from the CRD 310 merchant cash that was inserted into the CRD 310 over a period of time by the merchant 360. After removing the merchant cash, the armored car transports to the financial institution 350 the merchant cash removed from the CRD 310. When the merchant cash removed from the CRD 310 is delivered to the financial institution 350 (e.g., the next business day), new vault cash may be drawn from the merchant account 510 at the financial institution 350 and transported from the financial institution 350 to the CDD 320. The process of driving to the financial institution 350, withdrawing vault cash from the merchant account 510, transporting the vault cash to the CDD 320, inserting the vault cash into the CDD 320, removing from the CRD 310 merchant cash (e.g., PCS cash), transporting to the financial institution 350 the merchant cash that was removed from the CRD 310, and withdrawing new vault cash from the merchant account 510 may be repeated any number of times.

According to one embodiment, the merchant cash removed from the CRD 310 is transported directly from the merchant location 330 to the financial institution 350 (e.g., without stopping at a currency processing location). According to another embodiment, the merchant cash removed from the CRD 310 is transported 342 to a currency processing location, processed at the currency processing location, and transported 344 to the financial institution 350. The cash may be processed at the currency processing location in any of the manners described with reference to FIGS. 3 and 4, such as setting aside all or a portion of the cash to be physically transported 344 to the financial institution 350. If only a portion of the cash is set aside to be physically transported 344 to the financial institution 350, the remainder of the cash removed from the CRD 310 may be set aside to replenish a CDD at another merchant location. According to the embodiment described with reference to FIG. 5, the cash removed from the CRD 310 is not typically inserted into the CDD 320 during a subsequent site visit to the merchant location 330. Rather, the embodiment described with reference to FIG. 5 contemplates inserting into the CDD 320 vault cash that is drawn from the merchant account 510. Thus, if only a portion of the cash removed from the CRD 310 is set aside to be physically transported 344 to the financial institution 350, the remainder of the cash may be set aside to replenish a CDD at another merchant location (see, e.g., FIG. 7, which illustrates using vault cash belonging to the service provider 340 to fill the CDD) and an EFT 345 in the amount of the remainder may be made from a service provider account 520 (which may be at the financial institution 350 or at a different financial institution) to the merchant account 510.

Because the financial institution 350 may have previously extended credit to the merchant 360 for the cash that the merchant inserted into the CRD 310, the financial institution 350 may offset against the credit the financial institution 350 previously extended to the merchant 360 the cash that is transported 344 to the financial institution 350 and the EFT 345. In other words, if the financial institution 350 has already credited the merchant account 510 for all or a portion of the cash stored within the CRD 310 (e.g., after the CRD 310 transmits 312 to the financial institution 350 an indication of the amount of cash that is stored within the safe), the cash within the CRD 310 has already effectively been deposited into merchant account 510. Thus, instead of depositing into the merchant account 510 the cash that is transported 344 to the financial institution 350 and the EFT 345, the cash that is transported 344 to the financial institution 350 and the EFT 345 may be offset against the credit the financial institution 350 previously extended to the merchant 360.

The system 500 may be configured to permit a merchant-customer or a merchant-employee to withdraw cash from the CDD 320. If the user of the CDD 320 is a merchant-customer (e.g., using a standard ATM card from their bank), a transfer 322 is made from a bank account associated with the merchant-customer, such as a merchant-customer account 530, to the merchant account 510. In other words, each time a merchant-customer withdraws cash from the CDD 320, the merchant account 510 is credited for that withdrawal. The amount of the transfer is equal to the amount of cash that the merchant-customer withdrew from the CDD 320 and may include a surcharge (e.g., a $1 to $5 transaction fee). The merchant-customer account 530 is shown within the CDD 320 for ease of illustration (i.e., the merchant-customer account 530 is not actually located within the CDD 320). A CDD, such as an ATM, may cause the EFT 322 to be made from a bank account associated with the merchant-customer to the merchant account 510 by a conventional process.

If a merchant-employee or merchant-customer withdraws cash from the CDD 320 using a merchant card (e.g., to pay winnings to a merchant-customer, fill the cash register, or make a COD payment as described with reference to FIG. 3A), the cash is effectively drawn 540 from the merchant account 510. Because the vault cash within the CDD 320 belongs to the merchant 360, a transfer from one account to another need not occur. Instead, one or more of the financial institution 350, the CDD 320, or the remote processor, may record the transaction details, such as the date, time, and amount of the withdrawal and an indication of which merchant card was used to make the withdrawal (e.g., the account number of the card used or the PIN). The transaction details may be used by the merchant 360 for internal accounting purposes.

Thus, as should be appreciated in view of the teachings herein, utilizing a single merchant bank account, such as the merchant account 510, in connection with servicing a CDD (e.g., vault cash used to fill the CDD 320 is drawn from the merchant account 510) and a CRD (e.g., depositing into the merchant account 510 cash from the CRD 310) may offer certain advantages, including by way of example and not limitation one or more of the following: (1) providing a system that allows a merchant-customer and a merchant-employee to withdraw cash from a CDD; (2) allowing a service provider (e.g., service provider 340) to possibly reduce its fees for servicing the CDD by using cash belonging to the merchant (e.g., drawn on the merchant account 510) instead of borrowing cash from a financial institution (e.g., drawn on a bailment account) or using cash belonging to the service provider; (3) allowing the merchant to earn interest on the money deposited in the merchant account; (4) reducing bill jams and possibly service calls related to bill jams by using cash (e.g., notes or bills) drawn from the financial institution (which may be less worn); (5) performing an EFT 322 from a merchant-customer's account to the merchant account 510 may reduce the total amount of money that needs to be maintained in the merchant account 510; and (6) simplifying the accounting process for merchant-employee withdraws by using the merchant's cash to fill the CDD (e.g., if the cash within the CDD 320 was drawn from a bailment account and a merchant-employee withdrew cash to payout video poker winnings, the financial institution may need to perform additional processing, such as tracking whether a transaction is being performed by a merchant-customer and a merchant-employee and transferring money from a merchant account to the bailment account at the end of the day).

FIG. 6 is a block diagram illustrating a system 600 for servicing the CRD 310 and the CDD 320 in which vault cash within the CDD 320 belongs to a financial institution 620 (e.g., drawn from a bailment account 625). The system 600 is similar to the system 300 described with reference to FIG. 3A and the system 500 described with reference to FIG. 5 but the vault cash used to fill the CDD 320 is drawn from the bailment account 625 at the financial institution 620 and merchant cash from the CRD 310 is deposited into the account 510. In FIG. 6, reference numerals in the three hundreds (e.g., 310) indicate elements similar or identical to those of the same name and reference numeral that were described with reference to FIG. 3A (i.e., CRD 310) and reference numerals in the five hundreds (e.g., 510) indicate elements similar or identical to those of the same name and reference numeral that were described with reference to FIG. 5 (i.e., merchant account 510).

In the embodiment described with reference to the system 600, there is no need for the merchant 360 to prime the merchant account 510 by depositing into the merchant account 510, for example, $10,000 to $40,000 for each of the merchant's CDD 320 or for each merchant location. Instead, vault cash used to fill the CDD 320 is drawn from the bailment account 625 at the financial institution 620. The bailment account 625 may be associated with the financial institution 620 (as illustrated in FIG. 6) or the bailment account 625 may be associated with the financial institution 350. In other words, the merchant account 510 and the bailment account 625 may be at the same financial institution or at different financial institutions.

As previously described with reference to FIG. 3A, vault cash is transported 346 to the merchant location 330 and is inserted into the ATM 320 or other CDD during a site visit. The vault cash may be transported 346 by the service provider 340 itself or by a courier service that is operated or contracted by the service provider 340. The vault cash includes cash drawn from the bailment account 625 at the financial institution 620 and transported 348 from the financial institution 620. For example, personnel may periodically (e.g., once a week) drive an armored car to the financial institution 620 (e.g., a Federal Reserve Bank or Depot) and withdraw cash from the bailment account 625. The armored car transports the cash that was withdrawn from the bailment account 625 to the CDD 320 and the cash is inserted into the CDD 320 by the armored-car personnel. The financial institution 620 typically charges the service provider 340 bailment fees (e.g., interest) on the amount of cash borrowed or drawn from the bailment account 625.

During the same site visit, merchant cash that was inserted into the CRD 310 over a period of time by the merchant 360 is removed from the CRD 310. After being removed from the CRD 310, the merchant cash is transported to the financial institution 350. According to one embodiment, the merchant cash removed from the CRD 310 is transported directly from the merchant location 330 to the financial institution 350 (e.g., without stopping at a currency processing location). According to another embodiment, the merchant cash removed from the CRD 310 is transported 342 to a currency processing location, processed at the currency processing location, and transported 344 to the financial institution 350. The cash may be processed at the currency processing location in any of the manners described with reference to FIGS. 3 and 4, such as setting aside all or a portion of the cash to be physically transported 344 to the financial institution 350. If only a portion of the cash is set aside to be physically transported 344 to the financial institution 350, the remainder of the cash removed from the CRD 310 may be set aside to replenish a CDD at another merchant location. According to the embodiment described with reference to FIG. 6, the cash removed from the CRD 310 is not typically inserted into the CDD 320 during a subsequent site visit to the merchant location 330. Rather, the embodiment described with reference to FIG. 6 contemplates inserting vault cash, which is drawn from the bailment account 625, into the CDD 320. Thus, if only a portion of the cash removed from the CRD 310 is set aside to be physically transported 344 to the financial institution 350, the remainder of the cash may be set aside to replenish a CDD at another merchant location (see, e.g., FIG. 7, which illustrates using vault cash belonging to the service provider 340 to fill the CDD) and an EFT 345 in the amount of the remainder may be made from the service provider account 520 (which may be at the financial institution 350 or at a different financial institution, such as the financial institution 620) to the merchant account 510.

Before depositing the cash that is transported 344 to the financial institution 350 and the EFT 345 into the merchant account 510, the financial institution 350 may first determine whether it has previously extended credit to the merchant 360 for the cash that the merchant inserted into the CRD 310 (e.g., by checking a database for transactions involving the merchant 360). Because the financial institution 350 may have previously extended credit to the merchant 360 for the cash that the merchant inserted into the CRD 310, the financial institution 350 may offset against the credit the financial institution 350 previously extended to the merchant 360 the cash that is transported 344 to the financial institution 350 and the EFT 345. In other words, if the financial institution 350 has already credited the merchant account 510 for all or a portion of the cash stored within the CRD 310 (e.g., after the CRD 310 transmits 312 to the financial institution 350 an indication of the amount of cash that is stored within the safe), the cash within the CRD 310 has already effectively been deposited into merchant account 510. Thus, instead of depositing into the merchant account 510 the cash that is transported 344 to the financial institution 350 and the EFT 345, the cash that is transported 344 to the financial institution 350 and the EFT 345 may be offset against the credit the financial institution 350 previously extended to the merchant 360.

The system 600 may be configured to permit a merchant-customer or a merchant-employee to withdraw cash from the CDD 320. If the user of the CDD 320 is a merchant-customer (e.g., using a standard ATM card), a transfer 322 is made from a bank account associated with the merchant-customer, such as the merchant-customer account 530, to the bailment account 625. In other words, each time a merchant-customer withdraws cash from the CDD 320, the bailment account 625 is credited for that withdrawal. The amount of the transfer is equal to the amount of cash that the merchant-customer withdrew from the CDD 320. The merchant-customer account 530 is shown within the CDD 320 for ease of illustration (i.e., the merchant-customer account 530 is not actually located within the CDD 320). A CDD, such as an ATM, may cause the EFT 322 to be made from a bank account associated with the merchant-customer to the bailment account 625 by a conventional process.

If a merchant-employee or merchant-customer withdraws cash from the CDD 320 using a merchant card (e.g., to pay winnings to a merchant-customer, fill the cash register, or make a COD payment as described with reference to FIG. 3A), the cash is effectively drawn 617 from the merchant account 510. Because the vault cash within the CDD 320 belongs to the financial institution 620 (e.g., drawn on the bailment account 625), an EFT 618 (e.g., an EFT or ACH transfer) may be made from the merchant account 510 to the bailment account 625. The merchant account 510 may be debited transaction-by-transaction (e.g., after the cash is dispensed by the CDD 320) or once at the end of the business day for a total amount dispensed that day.

FIG. 7 is a block diagram illustrating a system 700 for servicing the CRD 310 and the CDD 320 in which vault cash within the CDD 320 belongs to the service provider 340 (e.g., drawn from a service provider account 720). The system 700 is similar to the system 300 described with reference to FIG. 3A, the system 500 described with reference to FIG. 5, and the system 600 described with reference to FIG. 6 but the vault cash used to fill the CDD 320 is drawn from the service provider account 720 at the financial institution 710 and merchant cash from the CRD 310 is deposited into the account 510. In FIG. 7, reference numerals in the three hundreds (e.g., 310) indicate elements similar or identical to those of the same name and reference numeral that were described with reference to FIG. 3A (i.e., CRD 310), reference numerals in the five hundreds (e.g., 510) indicate elements similar or identical to those of the same name and reference numeral that were described with reference to FIG. 5 (i.e., merchant account 510), and reference numerals in the six hundreds (e.g., 618) indicate elements similar or identical to those of the same name and reference numeral that were described with reference to FIG. 6 (i.e., EFT 618).

In the embodiment described with reference to the system 700, there is no need for the merchant 360 to prime the merchant account 510 by depositing cash into the merchant account 510, for example, $10,000 to $40,000 for each of the merchant's CDD 320 or for each merchant location. Instead, vault cash used to fill the CDD 320 is drawn from the service provider account 720 at the financial institution 710. The service provider account 720 may be associated with the financial institution 710 (as illustrated in FIG. 7) or the service provider account 720 may be associated with the financial institution 350. In other words, the merchant account 510 and the service provider account 720 may be at the same financial institution or at different financial institutions.

As previously described with reference to FIG. 3A, vault cash is transported 346 to the merchant location 330 and is inserted into the ATM 320 or other CDD during a site visit. The vault cash may be transported 346 by the service provider 340 itself or by a courier service that is operated or contracted by the service provider 340. The vault cash includes cash drawn from the service provider account 720 at the financial institution 710 and transported 348 from the financial institution 710. For example, personnel may periodically (e.g., once a week) drive an armored car to the financial institution 710 (e.g., a Federal Reserve Bank or Depot) and withdraw cash from the service provider account 720. The armored car transports the cash that was withdrawn from the service provider account 720 to the CDD 320 and the cash is inserted into the CDD 320 by the armored-car personnel. Because the vault cash is drawn from the service provider account 720, the service provider 340 may avoid the bailment fees (e.g., interest) on the amount of cash that would otherwise be borrowed or drawn from the bailment account (e.g., bailment account 625 in FIG. 6).

During the same site visit, merchant cash that was inserted into the CRD 310 over a period of time by the merchant 360 is removed from the CRD 310. After being removed from the CRD 310, the merchant cash is transported to the financial institution 350. According to one embodiment, the merchant cash removed from the CRD 310 is transported directly from the merchant location 330 to the financial institution 350 (e.g., without stopping at a currency processing location). According to another embodiment, the merchant cash removed from the CRD 310 is transported 342 to a currency processing location, processed at the currency processing location, and transported 344 to the financial institution 350. The cash may be processed at the currency processing location in any of the manners described with reference to FIGS. 3 and 4, such as setting aside all or a portion of the cash to be physically transported 344 to the financial institution 350. If only a portion of the cash is set aside to be physically transported 344 to the financial institution 350, the remainder of the cash removed from the CRD 310 may be set aside to replenish the CDD 320 during a subsequent site visit to the merchant location 330 or a CDD at another merchant location. Thus, if only a portion of the cash removed from the CRD 310 is set aside to be physically transported 344 to the financial institution 350, the remainder of the cash may be set aside to replenish the CDD 320 at the merchant location 330 (or a CDD at another location) during a subsequent site visit and an EFT 345 in the amount of the remainder may be made from the service provider account 720 to the merchant account 510. The service provider account 720 is shown within the service provider 340 for ease of illustration. The service provider account 720 may be at the financial institution 710 or at a different financial institution, such as the financial institution 350.

Because the financial institution 350 may have previously extended credit to the merchant 360 for the cash that the merchant inserted into the CRD 310, the financial institution 350 may offset against the credit the financial institution 350 previously extended to the merchant 360 the cash that is transported 344 to the financial institution 350 and the EFT 345. In other words, if the financial institution 350 has already credited the merchant account 510 for all or a portion of the cash stored within the CRD 310 (e.g., after the CRD 310 transmits 312 to the financial institution 350 an indication of the amount of cash that is stored within the safe), the cash within the CRD 310 has already effectively been deposited into merchant account 510. Thus, instead of depositing into the merchant account 510 the cash that is transported 344 to the financial institution 350 and the EFT 345, the cash that is transported 344 to the financial institution 350 and the EFT 345 may be offset against the credit the financial institution 350 previously extended to the merchant 360.

The system 700 may be configured to permit a merchant-customer or a merchant-employee to withdraw cash from the CDD 320. If the user of the CDD 320 is a merchant-customer (e.g., using a standard ATM card), a transfer 322 is made from a bank account associated with the merchant-customer, such as the merchant-customer account 530, to the service provider account 720. In other words, each time a merchant-customer withdraws cash from the CDD 320, the service provider account 720 is credited for that withdrawal. The amount of the transfer is equal to the amount of cash that the merchant-customer withdrew from the CDD 320. The merchant-customer account 530 is shown within the CDD 320 for ease of illustration (i.e., the merchant-customer account 530 is not actually located within the CDD 320). A CDD, such as an ATM, may cause the EFT 322 to be made from a bank account associated with the merchant-customer to the service provider account 720 by a conventional process.

If a merchant-employee or merchant-customer withdraws cash from the CDD 320 using a merchant card (e.g., to pay winnings to a merchant-customer, fill the cash register, or make a COD payment as described with reference to FIG. 3A), the cash is effectively drawn 617 from the merchant account 510. Because the vault cash within the CDD 320 belongs to the service provider 340 (e.g., drawn on the service provider account 720), an EFT 618 (e.g., an EFT or ACH transfer) is made from the merchant account 510 to the service provider account 720. The merchant account 510 may be debited transaction-by-transaction (e.g., after the cash is dispensed by the CDD 320) or once at the end of the business day for a total amount dispensed that day.

Although the embodiments described with reference to FIGS. 5, 6, and 7 contemplate that the vault cash within the CDD 320 belongs to one of the merchant 360 (e.g., drawn on the merchant account 510), the financial institution 620 (e.g., drawn on the bailment account 625), or the service provider 340 (e.g., drawn on the service provider account 720), it is possible that the vault cash within the CDD 320 belongs to one or more of the merchant 360, the financial institution 620, and the service provider 340. In other words, the vault cash may be comingled. Alternatively, a single transfer may be made to the financial institution 620 or 710 and that financial institution may make additional transfers to the appropriate accounts (e.g., the bailment account 625 or the service provider account 520).

If the vault cash is comingled (e.g., belongs to the financial institution 620 and the service provider 340) and the user of the CDD 320 is a merchant-customer, a transfer 322 is made from a bank account associated with the merchant-customer, such as the merchant-customer account 530, to the appropriate accounts (e.g., the bailment account 625 and the service provider account 720). For example, if 60% of the cash used to fill the CDD 320 was from the service provider 340 (e.g., the retained PCS cash) and 40% of the cash used to fill the CDD 320 was borrowed 348 from the financial institution 620 (e.g., drawn on the bailment account 625), a transfer for 60% of the amount withdrawn by the merchant-customer is made to a bank account of the service provider 340 (e.g., to the service provider account 720) and another transfer for 40% of the amount withdrawn by the merchant-customer is made to the financial institution 620 (e.g., to the bailment account 625). The CDD 320 (or a host processor with which the CDD 320 communicates) may be programmed with the appropriate transfer ratio (e.g., by the service provider 340 or financial institution 620).

If the vault cash is comingled (e.g., belongs to the financial institution 620 and the service provider 340) and the user of the CDD 320 is a merchant-employee, a transfer is made from a bank account associated with the merchant-employee, such as the merchant account 510, to the appropriate accounts (e.g., the bailment account 625 and the service provider account 720). The CDD 320 (or a host processor with which the CDD 320 communicates) may be programmed with the appropriate transfer ratio (e.g., by the service provider 340 or financial institution 620).

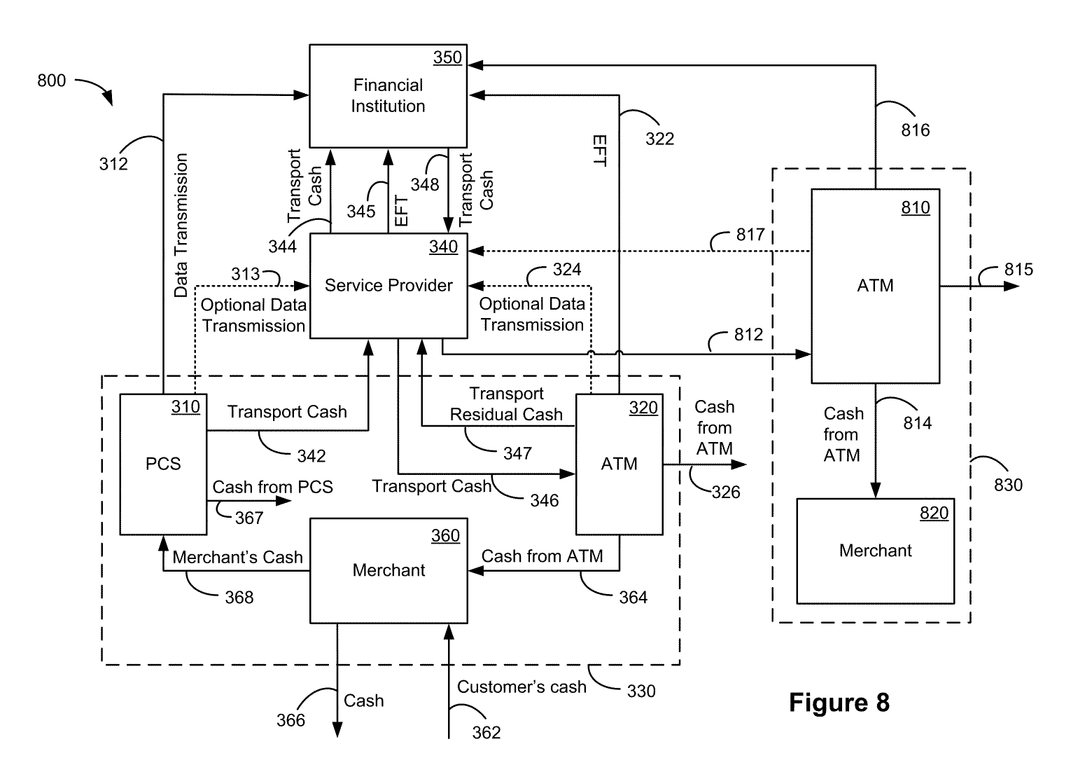

FIG. 8 is a block diagram illustrating a system 800 for servicing cash handling devices, such as the CRD 310 and the CDD 320 (which are both disposed at the merchant location 330) and a CDD, such as an ATM (which is disposed at another merchant location, such as merchant location 830). The system 800 is similar to system 300 described with reference to FIG. 3A but illustrates using the cash removed from the CRD 310 (e.g., PCS cash) to service the CDD, which is disposed at another merchant location 830. The merchant location 830 may or may not have a CRD. In FIG. 8, reference numerals in the three hundreds (e.g., 310) indicate elements similar or identical to those of the same name and reference numeral that were described with reference to FIG. 3A (i.e., CRD 310).

As described with reference to FIG. 3A, the cash within the CRD 310 is periodically removed from the CRD 310 and transported 342 to a service-provider location for processing. After the cash has been transported 342 to the service-provider location, the service provider 340 allocates a portion of the cash from the CRD 310 to be physically transported 344 to the financial institution 350 and deposited in the bank account of the merchant 360. The remainder of the cash from the CRD 310 is set aside to replenish during a subsequent site visit the CDD 320 at the merchant location 330, the CDD 810 at the merchant location 830, or both. A transfer 345, such as an EFT or ACH transfer, is made from a bank account of the service provider 340 to the financial institution 350 in the amount of the remainder.

The cash that was set aside to replenish the CDD 820 at the merchant location 830 during a subsequent site visit is then transported 812 to the merchant location 830 and is inserted into the CDD 810. If the cash removed from the CRD 310 is not sufficient to fill the CDD 320 and the CDD 810, the service provider 340 may need to borrow cash from the financial institution 350 and transport 348 the borrowed cash (possibly along with some of the cash removed from the CRD 310) to the merchant location 830 for placement in the CDD 810.

For “placed ATMs”, i.e., ones having dispensable cash that not the merchant's cash but is owned by a vault cash provider such as Cash Connect or Elan Financial Services, the cash dispensed by the CDD for the merchant's use, such as for CODs and lottery payouts, is withdrawn at the end of the day from a bank account the merchant has established for electronic withdrawals. For example, if the merchant believes he will dispense on average $5,000 a day for CODs and lottery payouts, he may establish an account at his bank with a balance of $10,000. Then, if in a given day, he dispenses $6,000 for CODs, or other dispensations, at the end of that day a financial institution like Cash Connect would withdraw $6,000 from the merchant's account. The merchant would then deposit $6,000 into his account to reestablish the $10,000 balance.

The CDD 810 may be similar or identical to the CDD 320 described with reference to FIGS. 3A and 3B. A user of the CDD 810 may, for example, withdraw cash from the CDD 810 to pay 814 the merchant 820 for goods or services or take 815 the withdrawn cash from the merchant location 830 to use for another purpose. The system 800 may be configured to permit a merchant-customer or a merchant-employee to withdraw cash from the CDD 810. If the user of the CDD 810 is a merchant-employee or merchant-customer using a merchant card (e.g., to pay winnings to a merchant-customer, fill the cash register, or make a COD payment as described with reference to FIG. 3A), a transfer 816 (e.g., an EFT or ACH transfer) may be made from a bank account associated with the merchant card, such as a bank account associated with the merchant 820. For example, if the vault cash within the CDD 810 belongs to one of the merchant, the service provider, or the financial institution, a transfer or transaction may be made from a bank account associated with the merchant 820 as described with reference to FIGS. 5, 6, and 7.

If the user of the CDD 810 is a merchant-customer using a standard ATM card, the CDD 810 (or a host processor with which the CDD 810 communicates) may cause a transfer 816, such as an EFT or ACH transfer, to be made from a bank account associated with the merchant-customer to a bank account associated with the CDD 810. For example, if the vault cash within the CDD 810 belongs to one of the merchant, the service provider, or the financial institution, a transfer or transaction may be made from a bank account associated with the merchant-customer as described with reference to FIGS. 5, 6, and 7.

The CDD 810 (or a host processor with which the CDD 810 communicates) may optionally transmit 817 to a computer system of the service provider 340 (or the host processor) an indication of the amount of cash that the merchant-employee or merchant-customer withdrew. The optional transmission 817 may, for example, help the service provider 340 determine when to service the CDD 810 (e.g., transport to and insert cash into the CDD 810).

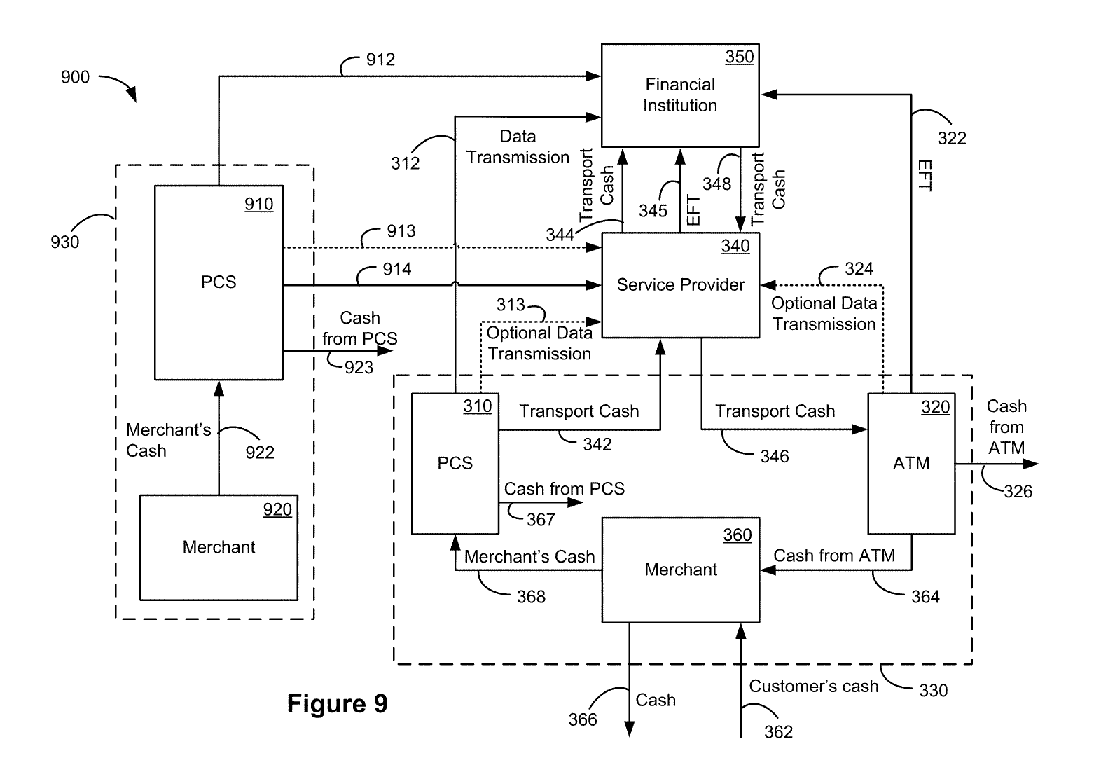

FIG. 9 is a block diagram illustrating a system 900 for servicing cash handling devices, such as the CRD 310 and the CDD 320 (which are both disposed at the merchant location 330) and a CRD 910 (which is disposed at another merchant location, such as a merchant location 930). The system 900 is similar to system 300 described with reference to FIG. 3A but illustrates using the cash removed from the CRDs 310 and 910 to service the CDD 320. The merchant location 930 may or may not have a CDD. In FIG. 9, reference numerals in the three hundreds (e.g., 310) indicate elements similar or identical to those of the same name and reference numeral that were described with reference to FIG. 3A (i.e., CRD 310).

During the ordinary course of business, a merchant 920 receives cash from its customers in exchange for the goods, services, or both, that the merchant 920 provides. After receiving cash, the merchant 920 inserts or feeds 922 the cash into the CRD 910 or other remote cash capture device (e.g., the merchant 920 or a merchant-employee may feed the cash into the CRD 910 immediately after receiving the cash or at some point thereafter). The merchant 920 (e.g., a merchant-employee, such as a manager or clerk) may withdraw cash 923 from the CRD 910 to, for example, pay winnings to a merchant-customer (e.g., if the merchant location 930 has gaming stations, such as video poker machines), fill the cash register, or pay for goods or services received (e.g., COD), which is described in greater detail with reference to FIG. 11. The CRD 910 may be similar or identical to the CRD 310 described with reference to FIG. 3A. Thus, the CRD 910 may comprise a safe, which includes a cash counter, a wired or wireless network interface, and other associated electronics. The network interface allows the CRD 910 to communicate (e.g., via a wired or wireless network) with the financial institution 350 and allows the CRD 910 to transmit 912 to the financial institution 350 an indication of the amount of cash that is stored within the safe so that the financial institution 350 can credit the merchant's account for that cash (or a portion thereof). For example, after the merchant 920 inserts or feeds 922 the cash into the CRD 910, the financial institution 350 receives a data transmission 912 (e.g., daily or after each deposit) indicating the amount of money that has been inserted into the CRD 910 so that the financial institution 350 can credit the merchant's bank account accordingly (e.g., within 24 hours or the next business day).

In addition to, or as an alternative to, transmitting 912 to the financial institution 350 an indication of the amount of cash that is stored within the safe, the CRD 910 may transmit 913 to the service provider 340 (or another location, such as a merchant server that communicates with CRDs disposed at various merchant locations) an indication of the amount of cash that is stored within the safe. For example, the CRD 910 may transmit 913 to the service provider 340 an indication of the amount of cash that is stored within the safe and the service provider 340 may relay that data to the financial institution 350. By way of another example, the CRD 910 may transmit to both the financial institution 350 and the service provider 340 an indication of the amount of cash that is stored within the safe, which may help the service provider 340 determine when to service the CRD 910 (e.g., remove cash from the CRD 910).

The cash within the CRD 910 is periodically removed from the CRD 910 and transported 914 to a currency processing location or service-provider location, such as a room of the service provider 340 for counting cash or processing EFTs. The cash that is removed from the CRD 910 may be transported 342 by the service provider 340 itself or by a courier service that is operated or contracted by the service provider 340. The service provider 340 or the courier service may utilize an armored or unarmored vehicle to transport the cash and the courier-service personnel may be armed or unarmed.

After the cash has been transported 914 to the service-provider location, the service provider 340 allocates all or a portion of the cash from the CRD 910 to be physically transported 344 to the financial institution 350 associated with the merchant 920 (e.g., the transported cash may be deposited into the bank account of the merchant 920 or used to offset the credit the financial institution 350 previously extended to the merchant 920 for the cash the merchant 920 fed into the CRD 910). The remainder of the cash from the CRD 910 (i.e., the cash from the CRD 910 that is not physically transported 344 to the financial institution 350) may be set aside to replenish the CDD 320 at the merchant location 330 (or a CDD of another merchant) during a subsequent site visit. To make whole the financial institution 350, the merchant 920, or both, a transfer 345, such as an EFT or ACH transfer, is made from a bank account of the service provider 340 to the financial institution 350 associated with the merchant 920 in the amount of the remainder to offset the credit the financial institution 350 previously extended to the merchant 920. In other words, because the financial institution 350 previously credited the merchant's account for the cash the merchant 920 fed into the CRD 910, the financial institution 350 should receive from the service provider 340 the tangible cash from the CRD 310 or an electronic deposit for the difference. The service provider 340 may optionally count the cash (e.g., using a cash counting machine) to verify the cash-count data reported by the CRD 910 or the service provider 340 may rely on the cash-count reported by the CRD 910.

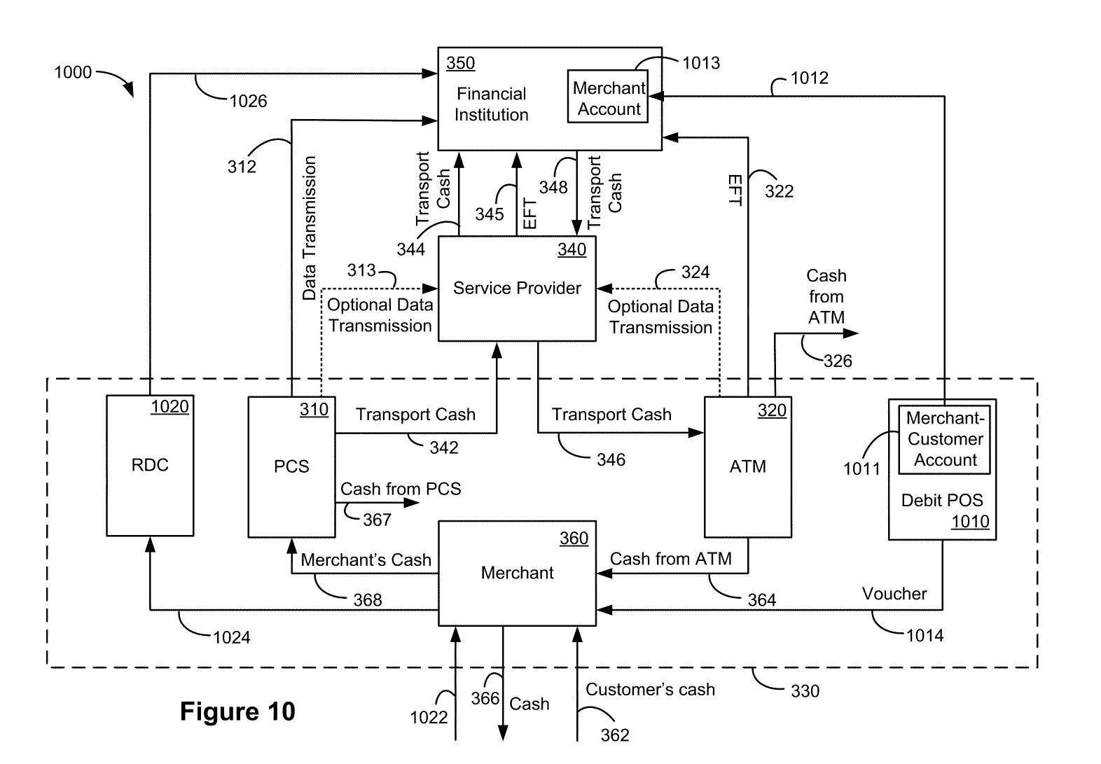

FIG. 10 is a block diagram illustrating a system 1000 for servicing cash handling devices, such as the CRD 310 and the CDD 320, that also includes a debit POS terminal 1010 and an RDC device 1020. Alternative embodiments may include the debit POS terminal 1010 but omit the RDC device 1020 or include the RDC device 1020 and omit the debit POS terminal 1010. The system 1000 is similar to system 300 described with reference to FIG. 3A but illustrates the use of the debit POS terminal 1010 and the RDC device 1020 in conjunction with the CRD 310 and the CDD 320. In FIG. 10, reference numerals in the three hundreds (e.g., 310) indicate elements similar or identical to those of the same name and reference numeral that were described with reference to FIG. 3A (i.e., CRD 310).

The transactions associated with the debit POS terminal 1010 (e.g., a PIN-based debit-POS terminal) are similar to ATM withdrawals in that money is transferred 1012 from a bank account 1011 of the debit POS terminal user to a bank account 1013 of merchant 360. Instead of delivering cash to the user, the debit POS terminal 1010 issues a voucher (e.g., scrip) to the user. The user then takes 1014 the voucher to a merchant-clerk to exchange it for cash (or the goods or services that the merchant 360 provides). The voucher is essentially a certificate that represents value for payee and payor. The voucher is not cash but may be converted into or exchanged for cash. If the merchant 360 does not have sufficient cash within the cash register, for example, a merchant-employee may need to withdraw cash from the CDD 320 to honor the voucher.

The RDC device 1020 allows checks to be electronically cashed and deposited into the merchant's account instead of having to physically transport the checks to the financial institution 350. During the ordinary course of business, the merchant 360 accepts 1022 checks from customers in exchange for goods or services. The checks are inserted 1024 into the RDC device 1020, which includes a scanner to capture an image of the checks (e.g., the front and backside of each check). The RDC device 1020 then transmits 1026 the images to the financial institution 350 and the merchant 360 will receive credit for those checks within 24-48 hours. The merchant 360 may optionally store the physical checks for a period of time if desired. Because the images of the checks are transferred to the financial institution 350 sooner, bad checks may be detected sooner (which may help improve the chances of collection because the check may be re-run sooner to see if the payor has sufficient funds in its checking account).

FIG. 11 is a functional block diagram of a CRD 1100, according to one embodiment, which may be used to implement the CRD 310 (see, e.g., FIGS. 3A-10), the CRD 910 (see, e.g., FIG. 9), or both. The CRD 1100 includes one or more currency recyclers that accept currency deposited into the CRD 1100 and use all or a portion of the deposited currency for future withdrawals from the CRD 1100. In other words, the CRD 1100 “recycles” the deposited currency. In addition, if too long of a period of time passes (e.g., two hours) without a deposit or dispensation, the CRD 1100 or a remote server in communication with the CRD 1100 may send an alert to a store manager or owner.

The CRD 1100 illustrated in FIG. 11 includes a bus-based architecture based on a bus 1105. Other types of architectures are also suitable, such a direct connection between one or more of the components. A number of components interface to the bus 1105, including one or more of a currency counter 1170, a currency recycler 1175, a display driver 1110, a card reader 1115, a printer controller 1120, a processor 1130, an input/output controller 1135, a memory 1140, a memory interface 1145, a network interface 1165, and an optical code reader. Other versions of the CRD 1100 may omit one or more of these components, may contain additional components, or both.

The currency counter or currency acceptor 1170 may comprise, for example, a bill counter that detects the denomination of the currency (e.g., $1 bills, $5 bills, $10 bills, and $20 bills), counts bills (e.g., by denomination), and possibly validates bills (e.g., determines whether the bills are authentic) that are inserted therein. The currency counter 1170 may optionally include a coin counter that detects the denomination of the coins, counts the coins, and possibly validates coins that are inserted therein. The currency counter 1170 may deposit the bills, coins, or both, into a safe within the CRD 1100 (e.g., a secure lockable box that protects against theft or damage). The safe may include a face that is removable or hinged to form a door. The body and/or door of the safe may be cast from metal, such as steel, or formed out of plastic. According to one embodiment, the bills are stacked in a cassette within the safe for easy removal. A suitable currency counter 1170 includes the SM/MSM BackLoad bill validator or CashCode One™ universal bank note validator offered by Crane Payment Solutions/CashCode of Concord, ON, Canada, or the CashFlow® SC, SCM offered by MEI of West Chester, Pa., USA, for example. The CRD 1100 may include one or more currency counters 1170, or the currency counter 1170 may be omitted.

The currency recycler 1175 accepts currency deposited into the CRD 1100 and dispenses currency in response to a request by a user of the CRD 1100. For example, a merchant or merchant-employee with the proper authority and prior set-up can periodically deposit cash into the currency recycler 1175 and also periodically withdraw cash from the currency recycler 1175 for ongoing operation of the merchant location (e.g., to pay winnings to a merchant-customer, fill the cash register, or make a COD payment as described with reference to FIG. 3A). The currency recycler 1175 may include a bill acceptor that detects the denomination of the currency (e.g., $1 bill, $2s, $5 bills, $10 bills, $20 bills, $50 bills, and $100 bills), counts the currency (e.g., by denomination), and checks for counterfeits (e.g., determines whether the currency is authentic or counterfeit). The currency recycler 1175 may optionally include a coin counter that detects the denomination of the coins, counts the coins, and possibly validates coins that are inserted therein. The currency recycler 1175 may include a recycling cassette to hold currency that can be recycled (e.g., currency that is dispensed via the bill acceptor in response to a request by a user of the CRD 1100). According to one embodiment, the recycling cassette is sized to store approximately sixty bills (e.g., sixty $20 bills). The recycling cassette may be sized to store additional or fewer bills. The currency recycler 1175 may also include a non-recycling cassette to store bills of any denomination, overflow bills from the recycling cassette (e.g., if the recycling cassette is full), or bills that are too worn to be recycled (bills that are too worn to be recycled may also be rejected by the currency recycler 1175). According to one embodiment, the non-recycling cassette is sized to store approximately six hundred bills to approximately seven hundred bills. The non-recycling cassette may be sized to store additional or fewer bills.

The bill acceptor diverts bill denominations specified for recycling to a recycling cassette. The bill acceptor diverts all other bills (including the denominations specified for recycling if the recycling cassette is full) to the non-recycling cassette. The recycling cassette and the non-recycling cassette may be disposed within a safe of the CRD 1100. A suitable currency recycler 1175 includes the Bill-to-Bill™ 60 currency management system offered by Crane Payment Solutions/CashCode of Concord, ON, Canada, for example. The CRD 1100 may include one or more currency recyclers 1175, or the currency recycler 1175 may be omitted.

According to one embodiment, the CRD 1100 includes one or more currency counters 1170 and omits the currency recycler 1175. According to another embodiment, the CRD 1100 includes one or more currency recyclers 1175 and omits the currency counter 1170. According to still another embodiment, the CRD 1100 includes one or more currency counters 1170 and one or more currency recyclers 1175. The currency counter(s) 1170 and currency recycler(s) 1175 may be mounted to a door of the safe and the currency counter(s) 1170 and currency recycler(s) 1175 may each include a slot (e.g., extending through the door and accessible from an exterior of the safe) for accepting currency. In addition, or alternatively, the currency counter(s) 1170 and/or the currency recycler(s) 1175 may be mounted on rails within the safe and the door of the safe may include one or more slots that extend through the door and are aligned with the currency counter(s) 1170 and/or the currency recycler(s) 1175 (when the door is closed) so that currency can be received or dispensed. The CRD 1100 may include a slot (e.g., a slot that is accessible from an exterior of the safe) for accepting currency and one or more conveying paths that couple the slot to the currency counter(s) 1170, the currency recycler(s) 1175, or both. The conveying path(s) may include belts or rollers that pinch currency there between as the currency is conveyed along the conveying path. The CRD 1100 may also incorporate a drop box (e.g., for checks or currency that could not be read by the currency counter or currency recycler).

According to one embodiment, the CRD 1100 is configured to transmit to a financial institution an indication of a total amount of currency that is inserted into the currency counter 1170 over a period of time so that the merchant is provided a credit by the financial institution for all or a portion of the currency inserted into the currency counter 1170 over the period of time as described with reference to FIGS. 3A-10. In other words, the currency inserted into the currency counter 1170 may be used to provide provisional credit to the merchant (e.g., the merchant associated with the merchant-location in which the CRD 1100 is installed). According to one embodiment, the currency inserted into the currency counter 1170 can only be accessed by the service provider 340 or a courier service that is operated by or contracted by the service provider, such as an armored car service. As described with reference to FIGS. 3A-10, the service provider 340 or courier service periodically (e.g., twice a week, once a week, or once every two weeks) makes a site visit to the merchant location after currency is inserted into the currency counter 1170 to pick up and transport/deposit the currency to the merchant's bank.

According to a another embodiment, the merchant receives a provisional credit from the merchant's financial institution for currency that is inserted into the currency counter 1170, but not for currency that is inserted into the currency recycler 1175 (e.g., currency inserted into the currency recycler may be dispensed before the service provider or courier makes a site visit to empty the CRD 1100). According to another embodiment, the merchant receives a provisional credit from the merchant's financial institution for currency that is stored in the currency counter 1170 and the non-recycling cassette of the currency recycler 1175, but not for currency that is stored in the recycling cassette of the currency recycler 1175. According to still another embodiment, the merchant also receives a provisional credit from the merchant's financial institution for all or a portion of currency that is stored in the recycling cassette of the currency recycler 1175.

A merchant or merchant-employee may use any access control device or method to deposit currency into the currency counter 1170 and the currency recycler 1175 and to withdraw currency from the currency recycler 1175. For example, the merchant or merchant-employee may key in access information or card data (e.g., one or more of a card number, account number, and PIN) using an input device 1136. By way of another example, the merchant or merchant-employee may use a card reader 1115 to read card data from a card. The one or more card readers 1115 may also write data to a card. One or more of the card readers 1115 may be integrated into the CRD 1100 or may be coupled to the CRD 1100 via the input/output controller 1135 and a connector 1137 (e.g., the card reader may be integrated into a keyboard that is coupled to the CRD 1100). The card reader 1115 may be omitted in certain embodiments.

Display driver 1110 interfaces with processor 1130 and a display 1111 to present, for example, in textual form, graphical form, or both, data or other information stored in one or more of memories 1140 and 1146. For example, the CRD 1100 may present data, menus, prompts, indications, and otherwise communicate with the user via one or more display devices 1111. The display 1111 may comprise any suitable display device, such as liquid crystal display (LCD), touch screen, or other display device.

The CRD 1100 may also include printer controller 1120 to interface with a printer 1121 (e.g., via a bi-direction port, such as a IEEE 1284 parallel port, a RS232 port, a USB port, or a wired or wireless network connection). The printer 1121 may be used, for example, to print receipts or summary reports for merchants. A bill dispenser or coin dispenser may optionally be provided to dispense cash to the merchant. According to one embodiment, the bill dispenser includes a currency source or safe, a dispensing aperture from which the cash is dispensed, and a conveyor or routing system for transporting cash from the currency source to the dispensing aperture. The bill dispenser is operable to selectively dispense one or more denominations of cash (i.e., four or more denominations) in response to one or more instructions from the processor 1130. According to one embodiment, the bill dispenser is incorporated in the currency recycler 1175.

The processor 1130 may be any form of processor and is a digital processor, such as a general-purpose microprocessor or a digital signal processor (DSP), for example. The processor 1130 may be readily programmable, hard-wired (e.g., an application specific integrated circuit (ASIC)), or programmable under special circumstances (e.g., a programmable logic array (PLA) or field programmable gate array (FPGA)). Program memory for the processor 1130 may be integrated within the processor 1130, may be part of the memory 1140 or 1146, or may be an external memory. The processor 1130 executes one or more programs to control the operation of the other components, to transfer data between the other components, to associate data from the various components together (in a suitable data structure), to perform calculations using the data, to otherwise manipulate the data, and to present results to the customer. For example, processor 1130 executes one or more modules that implement the methods described herein.

The input/output controller 1135 interfaces to one or more user input devices, such as a keypad or keyboard 1136, a pointing device, a trackball, or other wired or wireless input devices. Accordingly, the input/output controller 1135 may include hardware, software, firmware, or any combination thereof, to implement one or more protocols, such as stacked protocols along with corresponding layers. Thus, the input/output controller 1135 may function as a RS232 port, a USB port, an Ethernet port, a parallel port, an IEEE 1394 serial port, and an IR interface. The input/output controller 1135 may also support various wired, wireless, optical, and other communication standards. While the input devices may be integrated into the CRD 1100 and coupled to processor 1130 via the input/output controller 1135, the input devices may also connect via other interfaces, such as connector 1137.

The CRD 1100 may also include an optical code reader or data reader coupled to the bus 1105 or the input controller 1135. Optical code readers are used to capture optical codes (e.g., barcodes) or other symbols or information imprinted on various surfaces in order to read the information encoded in the optical code or symbol. The optical code reader may comprise a flying spot scanner or an imaging based scanner. Flying spot laser scanners generally obtain optical code information by sweeping a laser spot across the optical code. The laser spot may be generated by a laser light source which is then directed towards an oscillating or rotating reflecting surface, typically a mirror. The light reflected from the optical code is collected by a photosensor, which outputs an analog waveform representing the relative spacing of the bars in the optical code. The analog signal may then be digitized and decoded into data representing the information encoded in the optical code. Imaging based readers typically include solid state image circuitry, such as charge coupled devices (CCDs) or complementary metal-oxide semiconductor (CMOS) devices, and may be implemented using a one-dimensional or two-dimensional imaging array of photosensors (or pixels) to capture an image of the optical code. One-dimensional CCD readers capture a linear cross section of the optical code, producing an analog waveform whose amplitude represents the relative darkness and lightness of the optical code. Two-dimensional CCD or CMOS readers capture an entire two-dimensional image, which may be used to search for and decode (e.g., via the processor 1130) a barcode or optical code using any suitable technique (e.g., a two-dimensional decoding algorithm).

The CRD 1100 further includes memory 1140, which may be implemented using one or more standard memory devices. The memory devices may include, for instance, RAM 1141, ROM 1142, or EEPROM devices, and may also include magnetic or optical storage devices, such as hard disk drives, CD-ROM drives, and DVD-ROM drives. The CRD 1100 also includes a memory interface 1145 coupled to an internal hard disk drive 1146. The interface 1145 may also be coupled to an internal drive, such as an optical disk drive, or an external drive, such as a drive coupled to the CRD 1100 over a USB, IEEE 1194, or PCMCIA connection. The interface 1145 may also be coupled to a removable memory, such as flash memory.

In one embodiment, any number of program modules are stored in the memory 1140 or the drive 1146, including an operating system (OS) 1150, one or more program modules or components 1155, and data 1160. Any suitable operating system 1150 may be employed. One or more of the program modules 1155 may comprise a set of instructions that implement one or more of the methods described herein.

The network interface 1165 may be provided to communicate with an external network and one or more remote servers or data stores. For example, the network interface 1165 may communicatively couple the CRD 1100 to one or more of the service provider computer systems, the merchant computer systems, the financial institution computer systems, and the courier service or armored car company computer systems as described with reference to FIGS. 3A-10. In other words, one or more computer systems may communicate with the CRD 1100 via the network interface 1165 to allow, for example, one or more merchants, financial institutions, and armored car companies to send or receive data associated with the currency that is inserted into the CRD 1100 or withdrawn from the CRD 1100 (e.g., via the currency recycler 1175). The network interface 1165 may comprise a modem or network card that connects to an EFT network, such as an interbank network or other proprietary network that transmits financial information and to which access is restricted. The network interface 1165 may facilitate wired or wireless communication with other devices over a short distance (e.g., Bluetooth™) or nearly unlimited distances (e.g., the Internet). In the case of a wired connection, a data bus may be provided using any protocol, such as IEEE 802.3 (Ethernet), advanced technology attachment (ATA), personal computer memory card international association (PCMCIA), or USB, for example. A wireless connection may use low or high powered electromagnetic waves to transmit data using any wireless protocol, such as Bluetooth™, IEEE 802.11b (or other Wi-Fi standards), infrared data association (IrDa), or radio frequency identification (RFID), for example. According to one embodiment, the CRD 1100 may communicate (e.g., via the network interface 1165) with the computer system of the financial institution 350, the computer system of the service provider 340, or both, without using any EFT networks. The CRD 1100 may instead communicate with the computer system of the financial institution 350, the computer system of the service provider 340, or both, using a suitable public network, such as the internet.

Embodiments may be provided as a computer program product including a nontransitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the internet or other networks. For example, distribution of software may be via CD-ROM, internet download, or other distribution conduit.

### Currency Management

According to one embodiment, the CRD 1100 is configured to present via the display 1111a main menu of user-selectable parameters or options, including one or more of a deposit menu, a withdrawal or dispense menu, a lottery payout menu, and a report menu. As directed by the display 1111, the user may enter a user identifier and a PIN, password, or code and select a desired option (e.g., the deposit menu, dispense menu, lottery payout menu, or report menu). According to one embodiment, the user enters a user ID and password via the input device 1136. According to another embodiment, the user inserts or swipes a magnetic stripe card into or through card reader 1115 and, following a prompt that appears on the display 1111, the user types into the input device 1136 (e.g., a keyboard) a PIN, which is a numeric code between four and six digits in length.

After the user enters a user identifier and a PIN, the CRD 1100 authenticates the user's identity and determines the eligibility of the user to use the CRD 1100 (e.g., deposit or withdraw currency or generate a report). According to one embodiment, the CRD 1100 may compare the user identifier and personal identification code entered or provided by the user with a master list defining a set of users entitled to use the CRD 1100. For example, the data on the magnetic-stripe card and the PIN may be compared with data tables stored in memory 1140 or 1146 to verify that the user is a valid CRD user. If a match is not found, an error message appears on the display 1111 and the user is requested to renter the user identifier and/or personal identification code. If a match is found, the CRD 1100 posts a message on the display 1111 prompting or requesting the user to select a desired option (e.g., the deposit menu, dispense menu, or report menu). The user identifier may be, for example, a user ID, data contained on the magnetic swipe card, or any other identifying user data, such as a retinal scan, fingerprint scan, or RF identification. The personal identification code may be, for example, a password and/or PIN.

If the user selects the deposit menu from the main menu, the user inserts currency into the CRD 1100 (e.g., via the currency counter 1170, the currency recycler 1175, or both). The currency can be inserted in any orientation. If currency is inserted into the currency counter 1170, the bill counter detects the denomination of the currency, counts bills (e.g., by denomination), and possibly checks for counterfeits (e.g., determines whether the currency is authentic or counterfeit). If currency is inserted into the currency recycler 1175, the bill acceptor detects the denomination of the currency, counts the currency (e.g., by denomination), and possibly checks for counterfeits. The bill acceptor diverts bill denominations specified for recycling (e.g., $20 bills) to a recycling cassette and other bills (including the denominations specified for recycling if the recycling cassette is full) to the non-recycling cassette. As previously described, the merchant may receive a provisional credit from the merchant's financial institution for currency that is stored in the currency counter 1170 and the non-recycling cassette of the currency recycler 1175.

According to one embodiment, after the user selects the deposit menu, the user may be prompted to indicate whether the deposit is a provisional credit deposit (e.g., a deposit for which the merchant should receive a provisional credit from the merchant's financial institution). If the user indicates that the deposit is a provisional credit deposit, the CRD may direct the inserted currency to the currency counter 1170 or the non-recycling cassette of the currency recycler 1175, for example, or instruct the user to insert the currency into a particular slot. In other words, if the user indicates that the deposit is a provisional credit deposit, the currency may bypass the recycling cassette (or another cassette that is not used for provisional credit deposits).

After inserting the currency, the user may indicate that they have completed inserting currency (e.g., the user may select a “deposit complete” option from the menu) and the CRD 1100 may return to the main menu. The CRD 1100 may optionally print a report (e.g., via the printer 1121) indicating the identity of the user that deposited the currency, the time and date of the deposit, and number and dollar amounts of each denomination along with the total amount of the deposit. This information may also be stored in the memory 1140, 1146, or both, and may be accessed by or transmitted to a remote computer system (e.g., one or more of the service provider computer systems, the merchant computer systems, the financial institution computer systems, and the courier service or armored car company computer systems as described with reference to FIGS. 3A-10).

As described with reference to FIG. 3A, the CRD 1100 may transmit (e.g., via the network interface 1165) to an appropriate financial institution 350, service provider 350, and/or another location (e.g., a server of a courier service or armored car company or a merchant server) an indication (e.g., a data file or bit stream) of the amount of currency that is stored within the CRD 1100 so that the financial institution 350 can credit the merchant's account for that currency. For example, after the user inserts or feeds the currency into the CRD 1100, the financial institution 350 receives a data transmission (e.g., after each deposit or periodically, such as at the end of the business day) indicating the amount of money that has been inserted into the CRD 1100 so that the financial institution 350 can credit the merchant's bank account accordingly (e.g., within 24 hours or the next business day).

If the user selects the dispense menu from the main menu, the CRD 1100 prompts (e.g., via the display 1111) the user to enter a desired withdrawal amount. For example, the CRD 1100 may prompt the user to select a fast-cash amount, such as $100 or $200, using the input device 1136. By way of another example, the CRD 1100 may prompt the user to select an amount divisible by a currency denomination available in the recycle cassette (e.g., divisible by $20 if the recycle cassette stores $20 bills or divisible by $5 if the recycle cassette stores $5 bills and $20 bills). After the user enters a desired withdrawal amount, the CRD 1100 compares the desired withdrawal amount with a permitted withdrawal amount stored in the memory 1140, 1146, or both. For example, the memory 1140, 1146, or both, may include a database containing records that link various user identifiers or cards to authorized maximum transaction amounts (e.g., maximum dispensation amounts per transaction or maximum dispensation amounts per day). The database allows the merchant to control the level of access of various merchant-employees. For example, a merchant may grant a merchant approved manager a larger maximum transaction amount than a merchant approved employee (e.g., a store clerk). If the desired withdrawal amount exceeds the maximum withdrawal amount stored in the memory 1140, 1146, or both, the operating sequence is terminated and the user may be asked to enter an alternative desired withdrawal amount.

If an appropriate desired withdrawal amount is entered, the CRD 1100 may dispense the requested currency (if, for example, the CRD 1100 does not include timed delay functionality) and the CRD 1100 may return to the main menu. In addition, or alternatively, the CRD 1100 may enter a delay period during which the CRD 1100 becomes inactive (e.g., the CRD 1100 does not dispense any currency). For example, the CRD 1100 may enter pre-dispensation delay during which the CRD 1100 is inaccessible for further dispensations. The timed delay may last anywhere from one minute to 99 minutes, for example. After expiration of the delay period, the CRD 1100 may dispense the currency or may request the user reenter their user identifier, personal identification code, or both. In the latter instance, the CRD 1100 sends a signal to the currency recycler 1175 to effect currency dispensation following correct reentry of their user identifier and/or personal identification code. The CRD 1100 may generate a timed delay between dispenses, a pre-dispensation delay (e.g., a timed delay before the currency is dispensed), a post-dispensation delay (e.g., a timed delay before the currency is dispensed), or a combination thereof. In some embodiments, the CRD 1100 may have either/both pre- and post-dispensation delay periods of approximately 1 to 10 minutes. In another embodiment, after a pre-dispensation delay period has expired, an individual may re-enter a password before money is actually dispensed, which inhibits the chance of dispensing cash without oversight or onto the floor.

The CRD 1100 may also regulate the timing of each dispensation such that a dispensation may be effected only during a specified period of time, thereby preventing currency dispensations outside of a specified period of time. For example, the CRD 1100 may be programmed so that no cash withdrawals are permitted during certain time periods, such as when the merchant location is closed. In this way, the CRD 1100 minimizes the incidence of robbery of the safe by either employees or outsiders. As another example, a first-shift employee may not be eligible to withdraw currency from the CRD 1100 during the second or third shift time intervals. For example, the CRD 1100 may compare the time of day at which the currency dispensation is requested to the permissible dispensation times stored in memory 1140, 1146, or both. If the user is not authorized to request a dispensation at that time, the transaction sequence is terminated.

The CRD 1100 may optionally print a report (e.g., via the printer 1121) indicating the identity of the user that withdrew the currency, the time and date of the withdrawal, and the amount of the withdrawal. This information may also be stored in the memory 1140, 1146, or both, and may be accessed by or transmitted to a remote computer system (e.g., one or more of the service provider computer systems, the merchant computer systems, the financial institution computer systems, and the courier service or armored car company computer systems as described with reference to FIGS. 3A-10).

If the user selects the lottery payout menu from the main menu, the CRD 1100 prompts (e.g., via the display 1111) the user to present the lottery slip or cash slip to the optical code reader, which scans and decodes the optical code (e.g., a barcode) on the lottery slip. The optical code on the lottery slip has encoded therein a payout amount (e.g., the merchant-customer's winnings) and possibly other information, such as a serial number that uniquely identifies the lottery slip and an indication of a gaming station that printed in lottery slip. For example, after winning $855 at a gaming station at the merchant location, such as an on-site video poker machine, the merchant-customer presents to the merchant-employee a lottery slip that was printed by the gaming station and includes an optical code having encoded therein an indication of the amount of the merchant-customer's winnings. After verifying the winnings (e.g., by scanning an optical code on the cash slip using a lottery verification computer system), the merchant-employee uses the CRD 1100 to pay the merchant-customer their winnings. For example, the merchant-employee enters their user identifier and personal identification code into the CRD 1100 and selects the lottery payout menu.

After the optical code reader scans and decodes the optical code on the lottery slip, the CRD 1100 dispenses (e.g., via the currency recycler 1175) an amount of currency equal to or approximately equal to the payout amount (e.g., the merchant-customer's winnings encoded in the optical code included on the lottery slip) and the CRD 1100 may return to the main menu. According to one embodiment, the amount of currency dispensed by the CRD 1100 is less than the payout amount. For example, if the merchant-customer won $855, the CRD 1100 may dispense $840 and the merchant-employee may pay the remaining $15 from the cash register. Alternatively, the merchant-employee could have the device dispense $860 and place the extra by dollars and to the cash register. The CRD 1100 may also generate a timed delay, such as the pre-dispensation delay (e.g., a timed delay before the currency is dispensed) or the post-dispensation delay (e.g., a timed delay before the currency is dispensed) described above.

Certain lottery slips or cash slips that include an optical code may not have the payout amount encoded in the optical code or the optical code reader associated with the CRD 1100 may not be able to decode the optical code to determine the payout amount. Thus, according to one embodiment, the CRD 1100 prompts the user to enter a desired withdrawal amount equal to or approximately equal to the payout amount. For example, after the user selects the lottery payout menu from the main menu, the CRD 1100 prompts the user to present the lottery slip or cash slip to the optical code reader, which scans the lottery slip and determines whether the lottery slip includes an optical code. According to one embodiment, the optical code reader determines that the lottery slip includes an optical code if the optical code reader scans and decodes at least one valid character, codeword, or overhead character. An optical code may comprise data characters (or codewords in the case of PDF417) and/or overhead characters represented by a particular sequence of bars and spaces (which may have varying widths) depending on the symbology being used (e.g., UPC, Code 39, Code 128, or PDF417). Optical codes typically contain data characters including a single group of bars and spaces that represent encoded numbers, letters, punctuation marks, or other symbols. If the optical code reader does not decode at least one valid character, codeword, or overhead character, the user may be prompted to rescan the lottery slip and/or the CRD 1100 may display an error message (e.g., no barcode found) and return to the main menu.

If the optical code reader decodes at least one valid character, codeword, or overhead character, the CRD 1100 prompts the user to enter a desired withdrawal amount (e.g., prompt the user to select a fast cash amount or enter an amount divisible by a currency denomination available in the recycle cassette using the input device 1136). After the user enters a desired withdrawal amount, the CRD 1100 compares the desired withdrawal amount with a permitted withdrawal amount stored in the memory 1140, 1146, or both, as described above with reference to the dispense menu. Certain embodiments may omit the step of comparing the desired withdrawal amount with a permitted withdrawal amount. If the desired withdrawal amount exceeds the maximum withdrawal amount, the operating sequence is terminated and the user may be asked to enter an alternative desired withdrawal amount. If a permitted desired withdrawal amount is entered, the CRD 1100 may dispense the requested currency (if, for example, the CRD 1100 does not include timed delay functionality) and the CRD 1100 may return to the main menu. In addition, or alternatively, the CRD 1100 may enter a delay period during which the CRD 1100 becomes inactive (e.g., the CRD 1100 does not dispense any currency).

According to one embodiment, after the user selects the lottery payout menu from the main menu, the CRD 1100 prompts the user to select whether the CRD 1100 should determine the payout amount from an optical code included with a lottery slip or whether the user wants to manually enter the payout amount as described above. In addition, or alternatively, the CRD 1100 may automatically determine whether the payout amount should be determined from the optical code included with a lottery slip or when the payout amount should be manually entered by the user. For example, the CRD 1100 may attempt to decode a barcode on the lottery slip and if it cannot determine the payout amount from the barcode, the CRD 1100 may prompt the user to manually enter the payout amount.

The CRD 1100 may store an indication of the lottery slips that have been used to dispense currency using the CRD 1100. For example, after scanning and decoding the optical code on the lottery slip or video poker slip, the CRD 1100 may store in the memory 1140, 1146, or both, an identifier associated with the lottery slip, such as a serial number that uniquely identifies the lottery slip or an indication of a gaming station that printed in lottery slip. The CRD 1100 may also transmit the identifier associated with the lottery slip to a remote computer system (e.g., to help prevent using the lottery slip at multiple locations to dispense currency). Before dispensing currency associated with a particular lottery slip, the CRD 1100 may first access the memory 1140, 1146, or both, to determine whether the lottery slip has already been used to dispense currency. In addition, or alternatively, the CRD 1100 may access a remote computer system to determine whether the lottery slip has already been used to dispense currency using a different CRD (e.g., at another merchant location). If the lottery slip has already been used to dispense currency, the CRD 1100 does not dispense currency. If, on the other hand, the lottery slip has not already been used to dispense currency, the CRD 1100 dispenses currency equal to or approximately equal to the payout amount and may return to the main menu.

The CRD 1100 may optionally print a report (e.g., via the printer 1121) indicating the identifier associated with the lottery slip, the identity of the user that withdrew the currency, the time and date of the withdrawal, and the amount of the withdrawal. This information may also be stored in the memory 1140, 1146, or both, and may be accessed by or transmitted to a remote computer system (e.g., one or more of the service provider computer systems, the merchant computer systems, the financial institution computer systems, and the courier service or armored car company computer systems as described with reference to FIGS. 3A-10). The CRD 1100 may also print a receipt that the merchant-employee can give to the merchant-customer. The receipt may include, for example, one or more of an indication of the payout amount, an indication of the lottery slip that they cashed in (e.g., the serial number of the lottery slip), an indication of the gaming station that printed the lottery slip, and the time and date.

If the user selects the report menu from the main menu, the CRD 1100 may enter a management mode in which one or more reports, such as the amount of currency deposited, the amount currency dispensed, and the amount of currency stored in the CRD 1100, are generated. The reports may be printed using the printer 1121 and/or the reports may be transmitted to remote computer system via the network interface 1165. After the report(s) are generated, the CRD 1100 may return to the main menu.

### Deposit and Dispensation Alerts

According to one embodiment, the CRD 1100 is configured to send an alert to a predefined set of individuals if a predetermined amount of time passes without a deposit, dispensation, or both, or a predetermined amount of currency is not deposited within a predetermined amount of time. For example, if a predetermined amount of time passes without a deposit (e.g., two hours passes since the last deposit) an alert may be sent to a merchant, store manager, or owner. By way of another example, if a predetermined amount of currency (e.g., $200) is not deposited in the CRD 1100 within a predetermined amount of time (e.g., two hours into a merchant-employees shift), an alert may be sent to a merchant, store manager, or owner. According to one embodiment, the predetermined amount of time is set to between approximately two hours and approximately four hours and the predetermined amount of currency is set to between approximately $200 and approximately $1,000. The predetermined amount of time and the predetermined amount of currency may also be adjusted by the merchant (e.g., the merchant may request the service provider to adjust the predetermined amount of time threshold and/or the predetermined amount of currency threshold).

The alert may include an indication of one or more of the predetermined amount of time (e.g., two hours have passed since the last deposit), the predetermined amount of currency (e.g., $200 has not been deposited two hours into a merchant-employees shift), the merchant location, and the merchant-employee (e.g., the person that should be making the deposit). The alert may comprise an email message, text message (e.g., instant messaging), telephone call (e.g., pre-recorded message) to predetermined number, or video message (e.g., surveillance video of the merchant location). If a convenience store employee, for example, does not make any deposits during their shift (or at an expected time during their shift, such as 10:00 AM), an alert can be sent to a store manager or owner so they can investigate and hopefully prevent the employee from absconding with the money collected (e.g., at the cash register) during their shift. The alert may also be indicative of some other problem at the merchant location, such as a power outage or a communication failure.

The alert may be sent by the CRD 1100, a remote computer system, or both. For example, the CRD 1100 may be programmed to send an alert (e.g., via the network interface 1165) if a predetermined amount of time passes without a deposit, dispensation, or both. By way of another example, a computer system may remotely monitor the CRD 1100 for deposits, dispenses, and amount of currency stored in the currency counter 1170, the currency recycler 1175, or both. If a predetermined amount of time passes without a deposit, dispensation, or both, at the CRD 1100 (e.g., if the amount of currency stored in the currency counter 1170, the currency recycler 1175, or both, does not change over a predetermined period of time) or a predetermined amount of currency is not deposited within a predetermined amount of time, the remote computer system is programmed to send the alert.

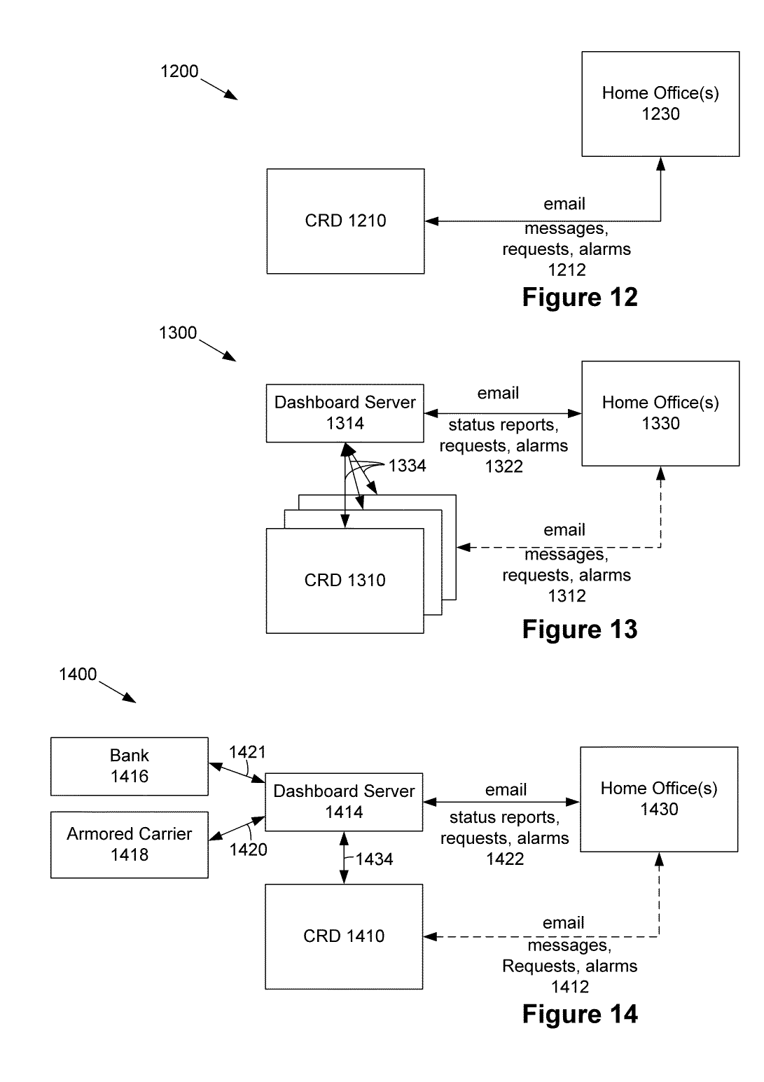

Depending on the operating mode and network configuration associated with a CRD, the computer system may comprise one or more of the service provider computer systems, the merchant computer systems, the financial institution computer systems, and the courier service or armored car company computer systems described with reference to FIGS. 3A-10. As described later in this document, FIGS. 12-14 provide three examples of different operating modes including a standalone mode, a dedicated monitoring service mode, and a combined cash-handling and monitoring mode.

The computer system may remotely monitor the CRD 1100 by periodically receiving an indication of the amount of currency stored in the CRD 1100. For example, the computer system may send a request to the CRD 1100 to provide an indication of the amount of currency stored in the currency counter 1170, the currency recycler 1175, or both. By way of another example, the CRD 1100 may be programmed to periodically send to the computer system an indication of the amount of currency stored in the currency counter 1170, the currency recycler 1175, or both. By way of still another example, the computer system may receive from the CRD 1100 an indication of the amount of money that has been inserted into the CRD 1100 or withdrawn from the CRD 1100 after each deposit or dispense.

The CRD 1100, the remote computer system, or both, may be configured to send alerts indicative of other events. For example, the CRD 1100 may include a tampering sensor, such as an accelerometer, that monitors the CRD 1100 for events that indicate that someone is tampering with the CRD 1100. If someone hits the CRD 1100 with a sledge hammer, for example, or attempts to pry open the CRD 1100 with a crowbar, for example, the accelerometer may detect motion above a predetermined threshold and the CRD 1100, the remote computer system, or both, may send an alert to a predefined set of individuals (e.g., an alert may be sent to a merchant, store manager, owner, alarm monitoring service, and/or police indicating that someone may be tampering with the CRD 1100).

The CRD 1100, the remote computer system, or both, may also be configured to send an alert if a user enters invalid data or if the CRD 1100 door is opened without an individual, employee, or an armored-car courier first logging in with a user name and password. For example, if the user enters an incorrect user identifier and/or personal identification code (e.g., once or more than three times), enters a desired withdrawal amount above a permitted withdrawal amount, or attempts to withdraw currency using a lottery slip that has already be used to dispense currency, the CRD 1100, the remote computer system, or both, may send an alert indicating that an unauthorized user may be attempting to use the CRD 1100.

Some individuals may have a user identification name and password that only allows depositing of cash into the CRD 1100. Other individuals may have a different/unique username(s) and password(s) that allow them to withdraw/dispense cash as well as deposit cash. User names/passwords can be associated with rules that limit the amount of cash withdrawn per transaction, define a maximum amount of cash a given user name/password can withdraw per day, and define a time/period between withdrawals. Individuals that are permitted to withdraw/dispense cash may also have two different passwords: one password is for normal dispenses and the second password is for distress withdrawals such as during a robbery, which is similar to the PIN-activated duress dispensations described in U.S. Pat. No. 7,726,557.

Some alerts may include a picture showing individual(s) who are opening the CRD 1100 safe door. The picture may be obtained via a camera integrated in the CRD 1100, for example, a camera of a Windows 8 touch-screen tablet or personal computer coupled to the CRD 1100 to provide a human interface device for the CRD 1100. In some embodiments, the CRD 1100 initiates a photo capture of an individual requesting a withdrawal of cash. Furthermore, the CRD 1100 sends an alarm and does not dispense cash in response to detecting that the camera is occluded. For example, the CRD 1100 determines whether recognizable faces or background features are absent from a photo in order to detect an occluded camera. The alarm indicating an occluded camera inhibits someone from placing tape or gum onto the tablet camera.

Because the tablet and a personal computer sitting on the merchants countertop can be easily stolen, the tablet or the personal computer will/may contain a GPS monitoring device that permits the human interface to be traced/located via the internet, providing functionality similar to a LoJack.

The remote computer system may also be configured to send an alert if the CRD 1100 does not send a communication to the remote computer system at an expected time and/or within an expected time period. For example, the CRD 1100 may be configured to periodically (e.g., once every two seconds to once every two minutes, and typically once every ten seconds) send a message or ping to the remote computer system. The message may include an indication that the CRD 1100 is operating properly. If the remote computer system does not receive a predetermined number of messages (e.g., three messages within thirty seconds), the remote computer system may send an alert indicating that there may be a problem with the CRD 1100 (e.g., the CRD 1100 may be down or inoperable, may have lost power, or is experiencing a communication failure). Furthermore, if the communication of the network interface 1165 is disconnected or terminated, the CRD 1100 will not permit dispensations, even if the CRD 1100 and its and the human interface display are operational.

Further to this process of monitoring deposits, the controller or control program may be configured whereby the amount and timing of deposits to the CRD is monitored. For example, the computer system may expect to receive regular/periodic notifications of a given amount of currency having been deposited into the CRD. If a deposit of a given amount is not made within the given time period (e.g., $200 deposited within a sixty minute time frame), a No Deposit (or low deposit) alert may be sent to the predefined set of alert individual(s) (e.g., a merchant, store manager, owner, alarm monitoring service, and/or police). This No Deposit alert may be generated by the computer system monitoring the CRD or it may be generated by the controller or by the CRD itself. The alert may be sent via email, text message, phone message or via other suitable mechanism. Following are example No Deposit alerts comprising example emails to the store owner as follows

Alert Example #1—ALERT! Cash Safe #20 at 200 Main Street less than $300 deposited in the last 180 minutes—. The alert individual is thus alerted that the expected deposit amount was not made within a given time window.

Alert Example #2—ALERT! Cash Safe #30 at 100 South Avenue no deposit in the last 120 minutes—. The alert may be set merely to log deposits, indicating that no deposit was made during a time period. The lack of any deposit may indicate a more serious problem such as store under external duress, equipment failure, or an employee procedure problem.

Alert Example #3—ALERT! Cash Safe #40 at Bob's Convenience Store 220 Fourth Avenue less than $300 in the last 180 minutes, $113 deposited—.

Alert Example #4—ALERT! Cash Safe #40 at Bob's Convenience Store 220 Fourth Avenue less than $300 in the last 180 minutes, $280 deposited—.

The information provided in the Example #3 and Example #4 alerts include both notification of the deposit not meeting the expected minimum but also the actual amount deposited. This additional deposit amount information allows the alert individual to evaluate the alert. A $113 deposit of Example #3 being much lower than the expected $300 may prompt action, whereas the $280 deposit of Example #4 being only a few dollars shy of the expected amount might be optionally ignored.

The various operations components may be part of the an overall system processor (such as processor 1130 in FIG. 11) or a more self-contained component such as dispenser alert module 2000. The alert system may include a memory, (such as system memory 1140 or 1146, included in the alert module 2000, or as external storage), for storing the various alerts and underlying information to enable the alert data and alert messages to be analyzed or reviewed.

More specific or potentially more accurate alert processes may be implemented such as in the following examples.
No Alert periods may be set for when a location is not open. For example, it may be known that a store is closed from midnight to 7 a.m. or the store is closed on Sundays. The system may be set/programmed to not send alerts during the closed periods. One way of setting the system to a no alert status during closed periods may be by setting the deposit amount to $0.
The actual dollar amount and time period for expected deposits may vary for different times of the day and/or different days of the week because it is expected that higher receipts are generated during different periods of the day. For example, from 7 a.m. opening until 12 noon; the dollar amount per 120 minutes may be set to $200; from noon until 8 p.m. the dollar amount may be set to $300 per 180 minutes.

Daily or time period parameters may also be set for individual weekday or weekend periods such that for businesses that have slow receipts on Monday and Tuesdays can be different (different time periods and lower dollar alert amounts) in comparison to busy Fridays and Saturdays. Each day can have separately set/programmed deposit alert amounts and time periods.

An alert may also be provided if the cash deposit exceeds a certain value. For example, if a deposit exceeds $5,000 in a certain period (in one period or collectively), such an event may indicate that the location may require additional security or monitoring or other action.

Alert function may be disabled or overridden for select periods such as when the location is closed for a period of time such as for remodeling.

Deposit data may be saved to generate historical data that may be analyzed to determine an expected flow of deposits over time, and based this historical data analysis provide a more precise expectation of deposit amounts for alert setting.

### Example Operating Modes of a CRD

### Local and Remote Monitoring

According to one embodiment, a remote computer system, such as the service provider computer system 372 described with reference to FIGS. 3A and 3B, is configured to monitor the amount of currency stored in the currency counter 1170, the currency recycler 1175, or both, and the amount of currency dispensed by the currency recycler 1175. The remote computer system may include any number of components, such as one or more of a processor, a memory, and a network interface, and is configured to communicate with one or more CRDs 1100 (e.g., via the network interface 1165 over a suitable wired or wireless network, such as the internet). The remote computer system may monitor multiple CRDs 1100 installed in various merchant locations. For example, the remote computer system may monitor multiple CRDs 1100 for a single merchant with multiple locations (e.g., a merchant with a chain of convenience stores). By way of another example, the remote computer system may monitor multiple CRDs 1100 for different merchants (e.g., a first CRD in a drug store of merchant A and a second CRD in a convenience store of merchant B).

Referring now to FIGS. 3B and 11, one or more merchants 360 (e.g., one or more merchants associated with the merchant locations 330a through 330n) may access the remote computer system to view data associated with the merchant's currency receiving and dispensing devices and to interact with the merchant's currency receiving and dispensing devices (e.g., set the alarm thresholds) via a webpage dashboard (or simply, the dashboard). For example, a merchant may access or log into the service provider computer system 372 to determine how much currency has been inserted into the CRD 1100 (e.g., stored within the CRD), the number of bills inserted by denomination (e.g., the number of $1 bills, $5 bills, $10 bills, etc.), and a banknote level indication (e.g., 80% full). The service provider computer system 372 may monitor the number and dollar amounts of each denomination along with the total amount of currency stored in the currency counter(s) 1170 and the currency recycler(s) 1175 (e.g., in the recycling and non-recycling cassettes) and transmit that data to the merchant or merchant-employee. The merchant may also view the identity of the user(s) that have deposited currency into the CRD 1100 and withdrawn currency from the CRD 1100, the time and date of the deposit(s) and withdrawal(s), and number and dollar amounts of each denomination along with the total amount of the deposit(s) and withdrawal(s). In addition, or alternatively, the service provider computer system 372 may send status updates to the merchant (e.g., daily emails indicating how much cash is within their CRDs) and send alerts as described above. The merchant may also be able to access historical data concerning their currency receiving and dispensing devices, such as a history of how much cash has been deposited into and withdrawn from their currency receiving and dispensing devices. A merchant or merchant-employee may access the service provider computer system 372 using any suitable device, such as a general-purpose computer, personal computer, or other device (e.g., mobile phone, smartphone, or internet-enabled mobile device), over a suitable wired or wireless network, such as the internet.

One or more financial institutions 350 may also access the remote computer system to view data associated with various merchant's currency receiving and dispensing devices. For example, a financial institution computer system may communicate (via data link 384) with the service provider computer system 372 to allow, for example, a financial institution to determine how much currency is stored in the CRD 1100 (e.g., in the currency counter 1170 or non-recycling cassette of the currency recycler 1175) so that the financial institution can credit the merchant's account for that currency.

One or more courier services or armored car companies 376 may also access the remote computer system to view data associated with various merchant's currency receiving and dispensing devices. For example, an armored car company computer system may communicate (via data link 388) with the service provider computer system 372 to allow, for example, the armored car company computer system to determine how much currency is stored in the CRD 1100 so that the armored car company can determine when to service the currency receiving and dispensing devices (e.g., make a site visit to remove merchant cash from the CRD and insert vault cash into the CDD). According to one embodiment, the CRD 1100 is configured to send a request for service (e.g., a request for a site visit to remove currency) to the armored car company computer system and/or the service provider computer system 372 after the amount of currency within the CRD 1100 exceeds a predetermined level. For example, the CRD 1100 may send a request for service after it is 80% full so that the armored car company can make a site visit to the merchant location and empty the CRD 1100.

After a service provider (e.g., service provider 340 in FIG. 3A) or a courier service, such as the armored car company 376, makes a site visit to a merchant location to service the CRD 1100, the service provider or courier service removes currency from the currency counter 1170, the currency recycler 1175, or both. According to one embodiment, only the service provider or courier service has access to and can remove currency from the currency counter 1170, the non-recycling cassette of the currency recycler 1175, or both. In other words, only the service provider or courier service (not the merchant or merchant-employee) can remove from the CRD 1100 currency for which the merchant receives a provisional credit from the merchant's financial institution. After the removing currency from the currency counter 1170, the non-recycling cassette of the currency recycler 1175, or both, the service provider or courier service transports the currency to an appropriate financial institution or service provider location as describe with respect to FIGS. 3A-10. The service provider or courier service may also have access to and remove currency from recycling cassette(s) or canister(s) of the currency recycler 1175. In other words, the service provider or courier service may remove the cassette(s) or canister(s) from the currency counter 1170, remove the recycling and non-recycling cassette(s) or canister(s) from the currency recycler 1175, and insert dispensable currency into an onsite CDD 320 in one site visit. The CRD 1100 may optionally generate and print a report (e.g., via the printer 1121) indicating the identity of the user that removed the currency, the time and date the currency was removed, and the amount of currency removed (e.g., the number and dollar amounts of each denomination along with the total amount of the currency stored in the removed cassette(s) or canister(s)).

According to one embodiment, a merchant or merchant-employee cannot open the CRD 1100 (e.g., cannot open the safe door and remove the cassette(s) or canister(s)). Rather, the merchant or merchant-employee withdraws cash from the CRD 1100 using the menus described above (e.g., the dispense menu and lottery payout menu). According to another embodiment, a merchant or merchant-employee can only remove currency from the recycling cassette(s) or canister(s) of the currency recycler 1175. In other words, a merchant or merchant-employee may be able to open the safe, remove the recycling cassette(s) or canister(s), and transport them to an appropriate financial institution for deposit (or set them aside to be picked up by a courier service). According to still another embodiment, a merchant or merchant-employee has access to and can remove currency from the currency counter 1170 and the recycling and non-recycling cassette(s) of the currency recycler 1175. For example, a merchant or merchant-employee may periodically (e.g., once a day, once a week, or when the CRD 1100 reaches its currency storing capacity), open the CRD 1100, remove the cassette(s) or canister(s) (e.g., from the currency counter 1170 or currency recycler 1175), and transport it to an appropriate financial institution for depositing. The CRD 1100 may optionally generate and print a report (e.g., via the printer 1121) indicating the identity of the user that removed the currency, the time and date the currency was removed, and the amount of currency removed (e.g., the number and dollar amounts of each denomination along with the total amount of the currency stored in the removed cassette(s) or canister(s)).

FIG. 12 shows a block diagram illustrating a first operating mode 1200 for a CRD 1210, which is the CRD 310, 910, or 1100. The mode 1200 is for a standalone CRD 1210 that provides messages, alarms, deposit amounts (including separate amounts for recycler or deposit cassettes) or other information 1212 directly to a home office 1230, so that the home office 1230 may then service the CRD 1210 when it requests configuration data or indicates cash cassettes are full.

During the business day a clerk or merchant deposits cash into the CRD 1210 and withdraws cash from a recycling cassette of currency recycler 1175. The CRD 1210 sends alarms—cassette-full, cassette partly full (80% full, for example), camera-blocked messages, and other alarms—directly to the home office 1230 or the onsite human interface device, such as a Windows 8 tablet device or laptop. Thus, reports of transactions, cash balances, and other reports are available onsite from the CRD 1210 interface (e.g., display 1111) and at the home office 1230 requesting the information 1212, which directly monitors the status of and merchant currency deposited in the CRD 1210.

The mode 1200 may be used, for example, by a small-business owner seeking to self-service the CRD 1210 by self-monitoring merchant currency via information 1212 requested directly from the CRD 1210. The owner may then self-transport the merchant currency to a financial institution without use of an armored transport service (which can cost $200 monthly), without receiving provisional-cash credit service (which can cost $60 monthly), or otherwise purchasing third-party merchant currency dashboard services described below. Accordingly, in the mode 1200, the CRD 1210 is independent (standalone) of an offsite dashboard server, communicates its information 1212 directly with the home office 1230, and does not report status or alerts to an intermediary offsite server or financial institution. In other words, in some embodiments, the CRD 1210 does not dynamically update an internet-based dashboard or participate in provisional-cash credit service options as in other embodiments described below with reference to FIGS. 13 and 14.

FIG. 13 shows a block diagram illustrating a second operating mode 1300 for a CRD 1310, which may be the CRD 310, 910, or 1100. The CRD 1310 information 1312 may be directly monitored, as described previously, or monitored via a dashboard server 1314 that provides dashboard reports, alarms, deposit amounts (including separate amounts for recycler or deposit cassettes) and other information 1322 for a home office 1330.

The home office 1330 is similar to the home office 1230 in that it also participates in for self-service cash handling. The home office 1330, however, may have anywhere from one to hundreds of CRDs in its portfolio, and therefore the dashboard server 1314 aggregates merchant currency transaction and status information 1334 from individual CRDs 1310 and provides an internet website dashboard with CRD portfolio reports. The dashboard server 1314 may be a third-party operated server, or may be a server operated and maintained by the home office 1330.

FIG. 14 shows a block diagram illustrating a third operating mode 1400 for a CRD 1410, which may be the CRD 310, 910, or 1100. The CRD 1410 information 1412 may be directly monitored, as described previously, or monitored via a dashboard server 1414 that is similar to the server 1314. Also, for merchants desiring provisional cash credit, the CRD 1410 is in communication with the internet-enabled dashboard server 1414, a provisional cash bank 1416, and an armored car courier 1418 to facilitate provisional credit as described above with reference to FIG. 3B, for example.

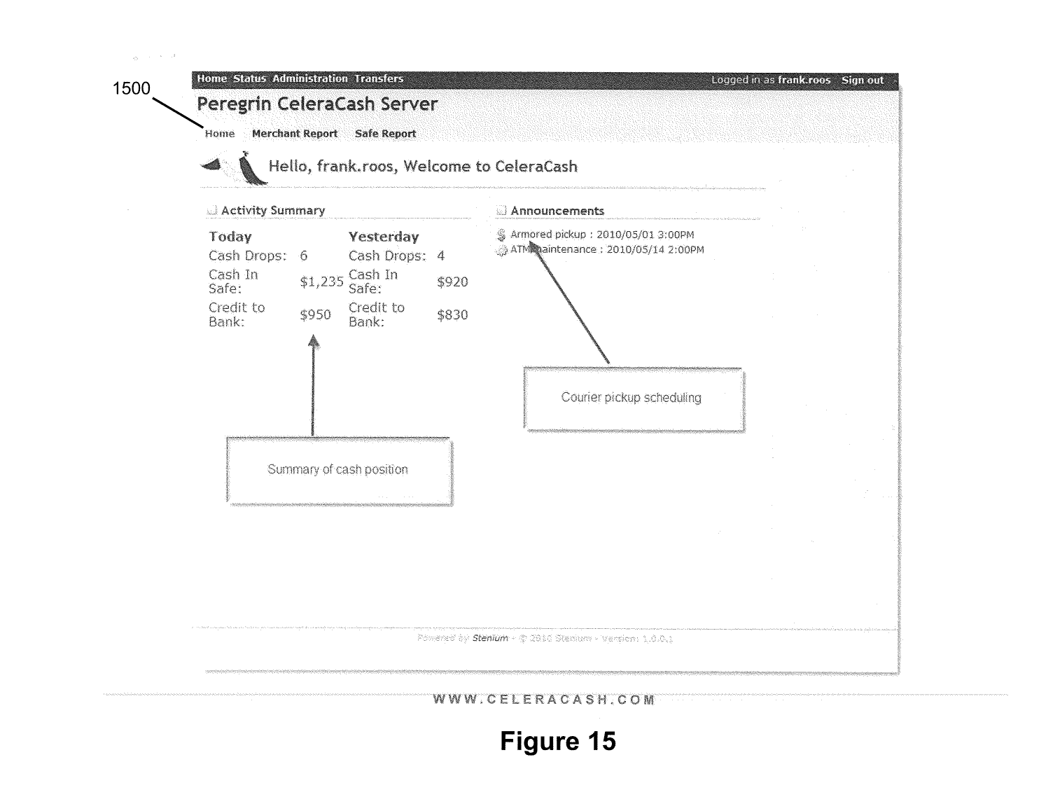

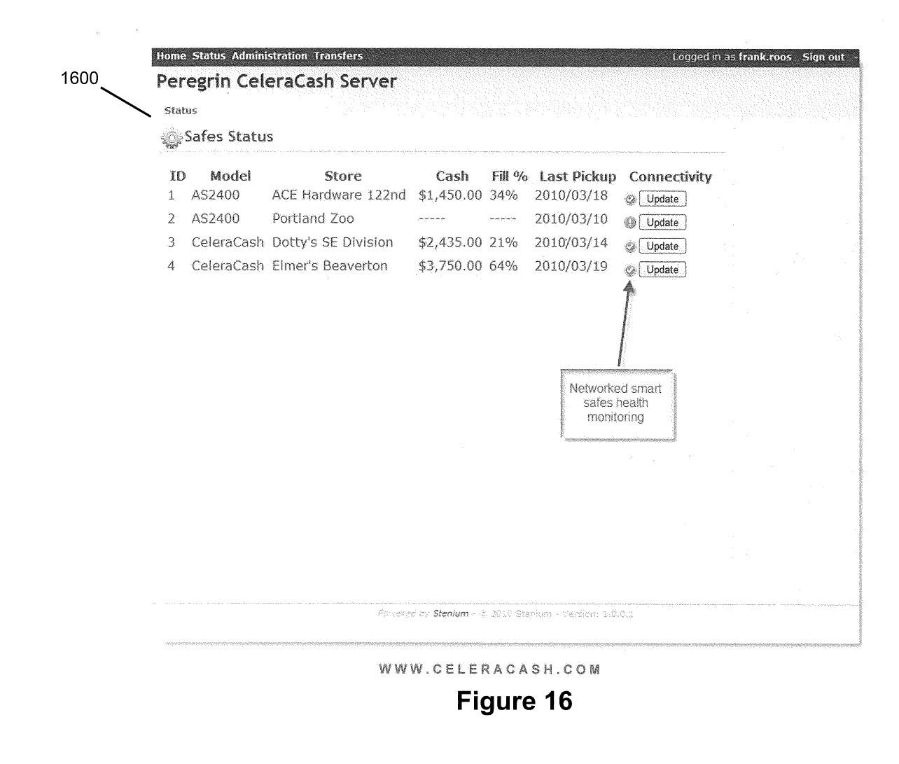

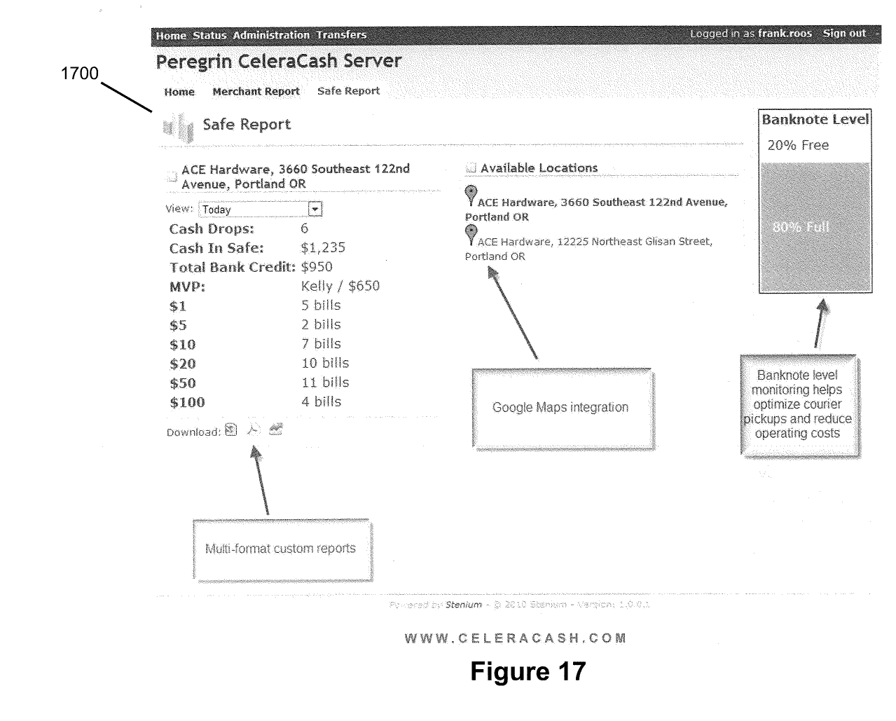

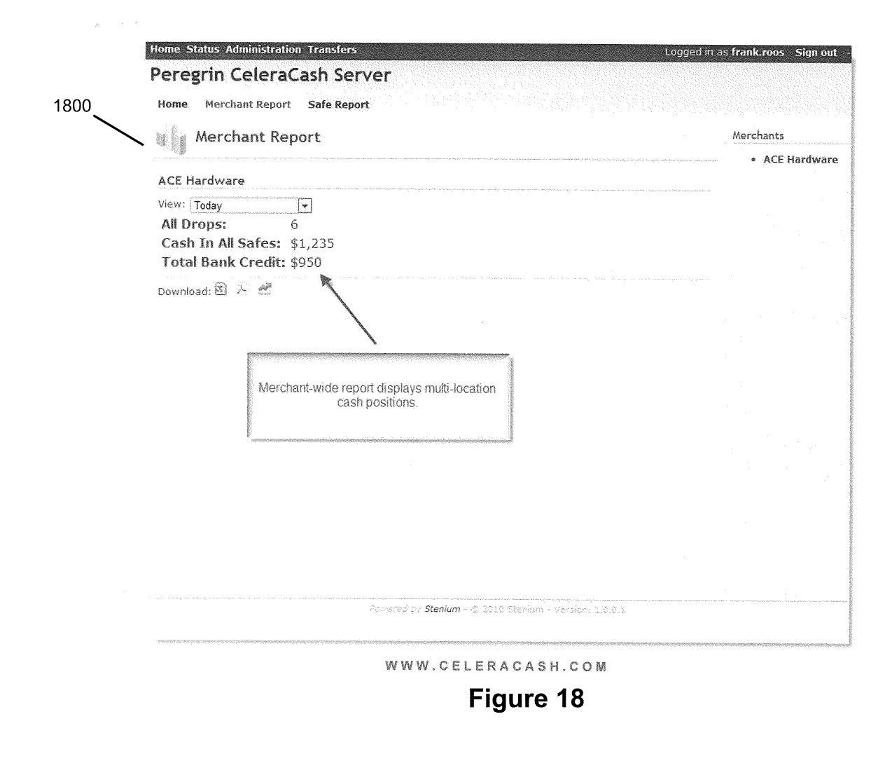

The dashboard server 1414 performs similar functions as the server 372 described with reference to FIG. 3B. For example, the dashboard server 1414 provides CRD information 1420 and 1421 to, respectively, the bank 1416 and the courier 1418. In response to the information 1420 sent via a data link that is similar to the data link 388 of FIG. 3B, the courier 1418 picks up cash from the CRD 1410 and provides the cash to the bank 1416. In response to the information 1421 sent via a data link that is similar to the data link 384 of FIG. 3B, the bank 1416 provides provisional-cash credit to a merchant (not shown) and reconciles the credit once the bank 1416 receives the cash. As discussed above with reference to FIG. 13, the server 1414 provides dashboard reports (1500, 1600, 1700 and 1800 of FIGS. 15-18), alarms, and other information 1422 to a home office 1430, based on information 1434 obtained from individual CRDs.

In one embodiment, a dashboard over report includes a top banner of account-holder and account-access information. A left-side column includes alert, communication status, and last pickup-service information for individual CRD terminals, a number of bills in a CRD cassette (by percentage of cassette capacity or total number of bills), and a dollar value of merchant currency in a CRD cassette. A bar chart indicates a number of bills for individual cassettes of a CRD terminal. A line chart shows amounts (i.e. cash values) deposited in a CRD at predetermined times in a predetermined period (e.g., a dollar amount deposited per day over a week). A dashboard cash transaction totals report has table with rows corresponding to individual CRDs, and columns corresponding to (1) a merchant currency deposited into a CRD deposit cassette in a predetermined period, and (2) checks and (3) merchant currency dropped in manually without being passed through the currency counter or recycler. As described previously, a merchant receives provisional-cash credit for the merchant currency deposited into a CRD deposit cassette(s). An additional column (4) of the cash transaction totals report shows an amount of merchant currency in the recycler cassette. One embodiment of dashboard reporting is a VersaLink® dashboard report available from Triton Systems, Inc. of Long Beach, Miss. Previous dashboard attempts, however, have not included dispensation features. One or more dashboards may be displayed in a single webpage, individually accessible as tabs of a webpage, or viewable as separate webpages.

It will be understood to skilled persons that many changes may be made to the details of the above-described embodiments without departing from the underlying principles of the invention. The scope of the present invention should, therefore, be determined only by the following claims.

1. A currency receiving device (CRD), comprising:
a currency counter configured to accept and count merchant currency inserted into the CRD;
a network interface; and
a processor in communication with the currency counter and the network interface, the processor configured to:
transmit to a financial institution, via the network interface, an indication of an amount of merchant currency inserted into the CRD over a first predetermined period of time;
determine whether a second predetermined period of time passes during which no merchant currency is inserted into the CRD; and
in response to determining that no merchant currency is inserted into the CRD during the second predetermined period of time, send an alert to a predefined set of one or more individuals, the alert indicating that no merchant currency has been inserted into the CRD during the second predetermined period of time.

2. The CRD of claim 1, further comprising a currency recycler configured to dispense merchant currency deposited inserted into the CRD

3. The CRD of claim 2, wherein the merchant is provided a credit by the financial institution for the amount of merchant currency inserted into the currency counter and is not provided a credit by the financial institution for the amount of merchant currency inserted into the currency recycler.

4. The CRD of claim 2, further comprising: an optical code reader; an input device; and a display, and wherein the processor is further configured to:
present via the display a menu of user-selectable options including a lottery payout menu;
in response to receiving via the input device a selection of the lottery payout menu, cause the optical coder reader to scan a lottery slip including an optical code, the lottery slip having a payout amount associated therewith; and
after the optical code is scanned by the optical code reader, dispense, via the currency recycler, an amount of currency equal to or approximately equal to the payout amount.

5. The CRD of claim 2, further comprising: an input device; and a display, and wherein the processor is further configured to:
present via the display a menu of user-selectable options including a dispense menu;
in response to receiving via the input device a selection of the dispense menu, prompt via the display a user to enter a desired withdrawal amount;
in response to receiving via the input device the desired withdrawal amount, determine whether the user is authorized to receive the desired withdrawal amount;
after it is determined that the user is authorized to receive the desired withdrawal amount and before dispensing an amount of merchant currency corresponding to the desired withdrawal amount, initiate a time delay period during which no additional determinations of whether a user is authorized to receive a desired withdrawal amount are made; and
after the time delay period has expired, dispense, via the currency recycler, an amount of merchant currency corresponding to the desired withdrawal amount.

6. The CRD of claim 5, wherein the processor is further configured to:
after the time delay period has expired and before dispensing the amount of merchant currency corresponding to the desired withdrawal amount, prompt the user to enter a user identification code;
authenticate the user by comparing the user identification code entered by the user to data in a master list, the data in the master list defining a set of valid user identification codes; and
if the user is authenticated, dispense the amount of merchant currency corresponding to the desired withdrawal amount.

7. A currency receiving device (CRD), comprising:
a currency counter configured to accept and count merchant currency inserted into the CRD;
a processor in communication with the currency counter, the processor configured to:
determine an amount of merchant currency inserted into the CRD over a first predetermined period of time;
determine whether the amount of merchant currency deposited into the CRD meets a predetermined minimum deposit corresponding to the first predetermined period of time; and
in response to determining that amount of deposited merchant currency does not meet the predetermined minimum deposit corresponding to the first predetermined period of time, send an alert to a predefined set of one or more individuals, the alert including an amount of merchant currency received by the receiving device during the first predetermined period of time.

8. A currency receiving device (CRD), comprising:
a currency recycler configured to accept and count merchant currency inserted into the CRD;
a door for accessing the merchant currency inserted into the CRD;
a human interface display touchscreen operative to receive user input data including username and password information associated with a user;
a network interface; and
a processor in communication with the currency recycler and the network interface, the processor configured to:
determine whether the door has been opened prior to receiving the user input data; and
in response to determining that the door has been opened, send an alert to a predefined set of one or more individuals, the alert indicating that the door has been opened prior to receiving the user input data.

9. The CRD of claim 8, further comprising a camera configured to acquire an image of the user.

10. The CRD of claim 9, wherein the camera is configured to acquire an image of the user in response to the user opening the door.

11. The CRD of claim 9, wherein the camera is configured to acquire an image of the user in response to the user requesting a withdrawal of merchant currency.

12. The CRD of claim 11, wherein the processor is further configured to recognize from the image whether the user is present at the CRD, and in response to determining the user is not present, disable dispensation of merchant currency.

13. The CRD of claim 9, wherein the processor is further configured to determine from the image whether a view of the camera is occluded, and in response to determining the view is occluded, disable dispensation of merchant currency.

14. The CRD of claim 8, wherein the processor is further configured to determine whether the user input data is associated with a user permitted to withdraw, deposit, or withdraw and deposit merchant currency.

15. The CRD of claim 14, wherein the processor is further configured to determine whether a predetermined period of time passes after a user has provided the user input data, and in response to determining that the predetermined period of time has expired, disable dispensation of merchant currency until the user reenters the user input data.

16. The CRD of claim 14, wherein the processor is further configured to determine, based on the user input data, a minimum period between withdraws that the user is permitted to withdraw merchant currency, and to disable dispensation of merchant currency after a dispensation of merchant currency and until the minimum period expires.

17. The CRD of claim 14, wherein the processor is further configured to determine, based on the user input data, an amount of merchant currency the user is permitted to withdraw per transaction or per day.

18. The CRD of claim 14, wherein the processor is further configured to determine whether the user input data includes a duress-dispensation code, and in response to determining the user input data includes a distress code, dispense merchant currency and send an alert to a predefined set of one or more individuals, the alert indicating the withdraw of merchant currency is under duress.

19. The CRD of claim 8, wherein the network interface receives information from a financial institution and establishes a communication connection therewith, and the processor is further configured to disable dispensation of merchant currency in response to the communication connection being disconnected.

20. The CRD of claim 8, wherein the network interface provides information to a dashboard server.

21. The CRD of claim 21, wherein the dashboard server communicates with a financial institution that provides provisional-cash credit.

22. The CRD of claim 8, wherein the human interface device includes a GPS monitoring device to provide location information of the human interface device.

23. The CRD of claim 8, wherein the processor is further configured to determine, whether a currency cassette of the currency recycler has been filled with a number of bills that meets or exceeds a predetermined number, and in response to determining that the currency cassette has been filled with a number of bills that meets or exceeds the predetermined number, send an alert to a predefined set of one or more individuals, the alert indicating the number of bills or a total dollar amount of the number of bills.
